(19) United States
(12) Patent Application Publication
(10) Pub. No.: US 2025/0364742 A1
(43) Pub. Date: Nov. 27, 2025

(54) HIGH-SPEED, HIGH-BANDWIDTH, AND HIGH-POWER CARD EDGE CONNECTOR

(71) Applicant: Amphenol Commercial Products (Chengdu) Co., Ltd., Chengdu (CN)

(72) Inventors: Jing Wang, Chengdu (CN); Luyun Yi, Chengdu (CN); Chao Hu, Chengdu (CN)

(73) Assignee: Amphenol Commercial Products (Chengdu) Co., Ltd., Chengdu (CN)

(21) Appl. No.: 19/214,721

(22) Filed: May 21, 2025

(30) Foreign Application Priority Data
May 22, 2024 (CN) 202421129588.6
Jan. 22, 2025 (CN) 202510101117.7
Jan. 22, 2025 (CN) 202520149796.0

(51) Int. Cl. H01R 12/75; H01R 12/72; H01R 13/6585

(52) U.S. Cl. CPC H01R 12/75; H01R 12/721; H01R 13/6585

(57) ABSTRACT

High-speed, high bandwidth, and high-power card edge connectors. A connector can be configured to receive a circuit board's edge portion that has multiple insertion portions separated from each other by notches. The connector include multiple slots, each of which is configured to receive a respective insertion portion. A first slot provides access to power conductors. A second slot provides access to both power and signal conductors. The other slots provide access to signal conductors. The signal conductors can be configured to provide high-speed signal transmission (e.g., 112 GT/s with PAM4) or sideband signal transmission. The power conductors can be configured to provide high-power transmission (e.g., 200 W), enabling support for more power-hungry devices like AI accelerators, storage controllers, or networking modules.

### CROSS-REFERENCE TO RELATED APPLICATIONS

This application claims priority to and the benefit of Chinese Patent Application No. 202510101117.7, filed on Jan. 22, 2025. This application also claims priority to and the benefit of Chinese Patent Application No. 202520149796.0, filed on Jan. 22, 2025. This application also claims priority to and the benefit of Chinese Patent Application No. 202421129588.6, filed on May 22, 2024. The contents of these applications are incorporated herein by reference in their entirety.

### TECHNICAL FIELD

The present application relates to interconnection systems, such as those including electrical connectors, configured to interconnect electronic assemblies.

### BACKGROUND

Electrical connectors are used in many electrical systems. Electronic devices have been provided with assorted types of connectors whose primary purpose is to enable data, commands, power and/or other signals to pass between electronic assemblies. A connector that carries both signals and power is sometimes called a hybrid connector. It is generally easier and more cost effective to manufacture an electrical system as separate electronic assemblies that may be joined with electrical connectors. For example, one type of electronic assembly is a printed circuit board (“PCB”). The terms “card” and “PCB” may be used interchangeably herein.

In some scenarios, a two-piece connector is used to join two assemblies. One connector may be mounted to each of the assemblies. The connectors may be mated, forming connections between the two assemblies.

In some other scenarios, a PCB may be joined directly to another electronic assembly via a one-piece connector, which may be configured as a card edge connector. The PCB may have pads along an edge that is designed to be inserted into an electrical connector attached to another assembly. Contacts within the electrical connector may contact the pads, thus connecting the PCB to the other assembly.

As will be appreciated, the connections provided by the electrical connectors are electrical connections that may communicate electrical signals and/or electrical power (e.g., electrical current and/or voltage).

The connectors and PCBs are typically designed and manufactured according to industry standards regarding aspects such as the mating interfaces with each other and signal and power requirements. For example, the Pluggable Multi-Purpose Module (PMM), defined by the SFF-TA-1034 specification, is a standardized hardware module designed to deliver high-speed data, power, and sideband signaling in data center and enterprise environments. The corresponding SFF-TA-1037 specification outlines the connector interface that facilitates the integration of PMMs into host systems.

### SUMMARY

Aspects of the present application relates to high-speed, high-bandwidth, and high-power card edge connectors.

Some embodiments relate to an electrical connector. The electrical connector may include a housing comprising a mating face, a first slot, a second slot, and a third slot each recessed into the housing from the mating face in a lateral direction, the first slot, the second slot, and the third slot sequentially arranged and spaced apart from each other in a longitudinal direction perpendicular to the lateral direction; and a plurality of conductive elements, each conductive element comprising a mating end having a mating contact portion disposed in a respective slot of the first, second and third slots, a contact tail configured for cable termination, and an intermediate portion joining the mating end and the contact tail. The plurality of conductive elements may include a plurality of first conductive elements, the mating contact portions of the mating ends of the plurality of first conductive elements disposed in the first slot; a plurality of second conductive elements, the mating contact portions of the mating ends of the plurality of second conductive elements disposed in the second slot; and a plurality of third conductive elements, the mating contact portions of the mating ends of the plurality of third conductive elements disposed in the third slot. Each first conductive element may be wider than each third conductive element in the longitudinal direction. Each third conductive element may be wider than each second conductive element in the longitudinal direction.

Optionally, the plurality of first conductive elements are configured for transmitting power; at least a portion of the plurality of second conductive elements are configured for transmitting signals; and the plurality of third conductive elements are configured for transmitting power.

Optionally, the housing comprises a first wall segment, a second wall segment, a first divider joining the first and second wall segments and separating the second and third slots, and first and second channels adjacent to the first divider and extending from the third slot into the first wall segment and the second wall segment, respectively, in a vertical direction perpendicular to both the lateral direction and the longitudinal direction; and the plurality of third conductive elements at least partially extend in the first and second channels.

Optionally, the plurality of conductive elements of the electrical connector comprises a plurality of fourth conductive elements; the mating contact portions of the mating ends of the plurality of fourth conductive elements are disposed in the third slot; each third conductive element is wider than each fourth conductive element; and the plurality of third conductive elements are disposed closer to the first divider in the longitudinal direction than the plurality of fourth conductive elements.

Optionally, the housing comprises a plurality of third channels; each third channel is narrower than each first or second channel; and the plurality of fourth conductive elements at least partially extend in the plurality of third channels.

Optionally, at least a portion of the plurality of fourth conductive elements are configured for transmitting signals; and each fourth conductive element has a same width as each second conductive element.

Optionally, the mating contact portions of the plurality of third conductive elements are arranged in two first rows in the longitudinal direction; the two first rows are opposed to and spaced apart from each other in the vertical direction; the mating contact portions of the plurality of fourth conductive elements are arranged in two second rows in the longitudinal direction; the two second rows are opposed to and spaced apart from each other in the vertical direction; and each of the two first rows and a corresponding one of the two second rows are aligned with and spaced apart from each other in the longitudinal direction.

Optionally, a pitch by which two adjacent mating contact portions of each first row are spaced from each other in the longitudinal direction is greater than a pitch by which two adjacent mating contact portions of each second row are spaced from each other in the longitudinal direction.

Optionally, each mating contact portion of the plurality of third conductive elements is wider than each mating contact portion of the plurality of fourth conductive elements in the longitudinal direction.

Optionally, the housing further comprises a third wall segment connected to the first wall segment, a fourth wall segment connected to the second wall segment, a second divider joining the third and fourth wall segments and separating the first and second slots, and fourth and fifth channels extending from the first slot into the third wall segment and the fourth wall segment in the vertical direction, respectively; and the plurality of first conductive elements at least partially extend in the fourth and fifth channels.

Optionally, the housing comprises an end wall joining the third and fourth wall segments, and an extension adjacent the first slot and configured for connecting to a panel; and the first slot is disposed between the second divider and the end wall and extends through the end wall.

Some embodiments relate to an electrical connector. The electrical connector may include a housing comprising a mating face, a plurality of slots each recessed into the housing from the mating face in a lateral direction, and a plurality of dividers each disposed between adjacent slots of the plurality of slots, the plurality of slots aligned in a longitudinal direction perpendicular to the lateral direction; and a plurality of conductive elements, each conductive element comprising a mating end having a mating contact portion disposed in a respective slot of the plurality of slots, a contact tail, and an intermediate portion joining the mating end and the contact tail. The plurality of conductive elements may include a pair of first conductive elements, each first conductive element comprising a plurality of first mating contact portions disposed in a first slot of the plurality of slots, a pair of second conductive elements, each second conductive element comprising a plurality of second mating contact portions disposed in a second slot of the plurality of slots, and a plurality of third conductive elements comprising third mating contact portions disposed in respective slots of the plurality of slots other than the first slot. Each first mating contact portion may be wider than each third mating contact portion in the longitudinal direction. Each second mating contact portion may be wider than each third mating contact portion in the longitudinal direction.

Optionally, each second mating contact portion is wider than each first mating contact portion in the longitudinal direction.

Optionally, the electrical connector may include a plurality of cables. The plurality of cables may include a plurality of first cables comprising first wires attached to the contact tails of the plurality of first conductive elements or the contact tails of the plurality of second conductive elements; and a plurality of second cables comprising second wires attached to the contact tails of the plurality of third conductive elements.

Optionally, the housing comprises a second face opposite the mating face, and a platform extending beyond the second face and traversing the plurality of dividers; and the plurality of cables are attached to respective contact tails on opposite sides of the platform.

Optionally, the housing comprises a pair of extensions disposed on opposite side of the housing in the longitudinal direction and configured for connecting to a panel.

Optionally, the mating contact portions of the plurality of second conductive elements have a first pitch of 0.6 mm; the mating contact portions of each second conductive element has a second pitch greater than the first pitch; and the mating contact portions of each second conductive element has a third pitch greater than the first pitch.

Optionally, the plurality of slots comprises a third slot disposed between the first and second slots, and fourth, fifth, and sixth slots separated from the first slot by the second slot.

Optionally, the sixth slot is the longest in the longitudinal direction among the plurality of slots and holds two rows of conductive elements; the plurality of dividers comprises a divider that is the widest in the longitudinal direction; and the sixth slot is separated from the fifth slot by the longest divider of the plurality of dividers.

Optionally, a plurality of shielding members at least partially extend in the plurality of slots other than the first slot; and each shielding member comprises plateaus disposed above pairs of third conductive elements, valleys attached to third conductive elements disposed between adjacent pairs of the pairs of third conductive elements, and connecting portions joining adjacent plateau and valley.

Some embodiments relate to an electrical connector. The electrical connector may comprises: an housing comprising a mating face, a first slot, a second slot, and a third slot each recessed into the housing from the mating face in a lateral direction, the first slot, the second slot, and the third slot sequentially arranged and spaced apart from each other in a longitudinal direction perpendicular to the lateral direction; and a plurality of conductive elements disposed in the housing, each conductive element comprising a mating end having a mating contact portion, a contact tail opposite to the mating end, and an intermediate portion joining the mating end and the contact tail. The plurality of conductive elements may comprises: a plurality of first conductive elements, the mating contact portions of the mating ends of the plurality of first conductive elements disposed in the first slot, and the plurality of first conductive elements configured for transmitting power; a plurality of second conductive elements, the mating contact portions of the mating ends of the plurality of second conductive elements disposed in the second slot, and at least a portion of the plurality of second conductive elements configured for transmitting signals; and a plurality of third conductive elements, the mating contact portions of the mating ends of the plurality of third conductive elements disposed in the third slot, and the plurality of third conductive elements configured for transmitting power.

Optionally, the housing further comprises: a first divider by which the second slot and the third slot are spaced apart from each other in the longitudinal direction; a first wall segment and a second wall segment spaced apart by the third slot in a vertical direction perpendicular to the lateral direction and the longitudinal direction; and a first channel and a second channel adjacent to the first divider and extending from the third slot into the first wall segment and the second wall segment in the vertical direction, respectively; and the plurality of third conductive elements at least partially extend in the first channel and the second channel.

Optionally, for each third conductive element: the mating end of the third conductive element comprises at least one first contact finger and at least two second contact fingers, each of the at least one first contact finger and the at least two second contact fingers has a mating contact portion disposed in the third slot; the mating contact portion of each first contact finger has a first width in the longitudinal direction, and the mating contact portion of each second contact finger has a second width in the longitudinal direction, the first width is greater than the second width; and the at least one first contact finger is closer to the first divider in the longitudinal direction than the at least two second contact fingers.

Optionally, for each third conductive element: the at least one first contact finger and the at least two second contact fingers are aligned with and spaced apart from each other in the longitudinal direction; and the mating contact portions of adjacent first contact finger and second contact finger of the at least one first contact finger and the at least two second contact fingers are spaced center-to-center from each other by a first pitch in the longitudinal direction, and the mating contact portions of two adjacent ones of the at least two second contact fingers are spaced center-to-center from each other by a second pitch in the longitudinal direction, the first pitch is greater than the second pitch.

Optionally, for each third conductive element: at least a portion of the intermediate portion of the third conductive element is disposed in a corresponding one of the first channel and the second channel; and each of the at least one first contact finger and the at least two second contact fingers comprises a straight segment, a curved segment, and a contact segment, the straight segment extends from the intermediate portion towards the mating face in the lateral direction in the corresponding channel, the curved segment is joined between the straight segment and the contact segment, the contact segment extends from the curved segment away from the mating face and into the third slot in the lateral direction, the mating contact portion is on the contact segment.

Optionally, for each third conductive element, the mating contact portion of the at least one first contact finger and the mating contact portions of the at least two second contact fingers are aligned with and spaced apart from each other in the longitudinal direction, and a contact surface of the mating contact portion of the at least one first contact finger and mating contact surfaces of the mating contact portions of the at least two second contact fingers are coplanar with each other.

Optionally, for each third conductive element, the straight segment of the at least one first contact finger and the straight segments of the at least two second contact fingers are aligned with and spaced apart from each other in the longitudinal direction.

Optionally, for each third conductive element: the widths of the straight segment, the curved segment and the contact segment of each first contact finger in the longitudinal direction are the same as each other.

Optionally, the widths of the straight segment, the curved segment and the contact segment of each second contact finger in the longitudinal direction are the same as each other.

Optionally, the at least one first contact finger and the at least two second contact fingers are aligned with each other in the longitudinal direction, each first contact finger has a first cross-sectional profile perpendicular to the longitudinal direction, and each second contact finger has a second cross-sectional profile perpendicular to the longitudinal direction, the first cross-sectional profile is the same as the second cross-sectional profile.

Optionally, the third conductive element is formed from a single piece of conductive material.

Optionally, the first width is at least 1.5 times the second width.

Optionally, the at least one first contact finger is a single first contact finger, and the at least two second contact fingers are two second contact fingers.

Optionally, the electrical connector is configured to establish a separable electrical connection with a circuit board comprising an insert portion configured to be inserted into the third slot, the insert portion comprises a plurality of contiguous conductive regions, the mating contact portion of the at least one first contact finger and the mating contact portions of the at least two second contact fingers of each third conductive element are configured to establish an electrical contact with a corresponding one of the plurality of contiguous conductive regions of the insert portion of the circuit board when the insert portion is inserted into the third slot.

Optionally, the first channel and the second channel are aligned with each other in the vertical direction.

Optionally, the plurality of third conductive elements comprise a pair of third conductive elements, one third conductive element of the pair of third conductive elements at least partially extends in the first channel, and the other third conductive element at least partially extends in the second channel.

Optionally, the first wall segment comprises a first inner surface facing towards the third slot and a first outer surface facing away from the third slot, the second wall segment comprises a second inner surface facing towards the third slot and a second outer surface facing away from the third slot, the first channel extends from the first inner surface into the first wall segment in the vertical direction, the second channel extends from the second inner surface into the second wall segment in the vertical direction, the first outer surface and the second outer surface are planar surfaces.

Optionally, the housing further comprises a first divider, the second slot and the third slot are spaced apart by the first divider in the longitudinal direction; and the plurality of conductive elements of the electrical connector further comprises a plurality of fourth conductive elements, the mating contact portions of the mating ends of the plurality of fourth conductive elements are disposed in the third slot, and at least a portion of the plurality of fourth conductive elements are configured for transmitting signals, the plurality of third conductive elements are disposed closer to the first divider in the longitudinal direction than the plurality of fourth conductive elements.

Optionally, the third slot comprises a first section adjacent to the first divider and a second section extending from the first section away from the first divider in the longitudinal direction; the mating contact portions of the mating ends of the plurality of third conductive elements are disposed in the first section; and the plurality of fourth conductive elements are disposed in the housing in correspondence with the second section, so that the mating contact portions of the plurality of fourth conductive elements are disposed in the second section.

Optionally, a first portion of the plurality of fourth conductive elements is configured for transmitting signals, and a second portion of the plurality of fourth conductive elements is configured for transmitting power; and the second portion of the plurality of fourth conductive elements is positioned between the first portion and the plurality of third conductive elements in the longitudinal direction.

Optionally, the mating contact portions of the plurality of third conductive elements are arranged in two first rows in the longitudinal direction, the two first rows are opposed to and spaced apart from each other in a vertical direction perpendicular to the lateral direction and the longitudinal direction, the mating contact portions of the plurality of fourth conductive elements are arranged in two second rows in the longitudinal direction, the two second rows are opposed to and spaced apart from each other in the vertical direction; each of the two first rows and a corresponding one of the two second rows are aligned with and spaced apart from each other in the longitudinal direction; a pitch by which two adjacent mating contact portions of each first row are spaced center-to-center from each other in the longitudinal direction is greater than a pitch by which two adjacent mating contact portions of each second row are spaced center-to-center from each other in the longitudinal direction; and a width of the mating contact portion of each third conductive element in the longitudinal direction is greater than a width of the mating contact portion of each fourth conductive element in the longitudinal direction.

Optionally, the housing further comprises: a second divider by which the first slot and the second slot are spaced apart in the longitudinal direction; a third wall segment and a fourth wall segment spaced apart by the first slot in a vertical direction perpendicular to the lateral direction and the longitudinal direction; and a third channel and a fourth channel extending from the first slot into the third wall segment and the fourth wall segment in the vertical direction, respectively; and the plurality of first conductive elements at least partially extend in the third channel and the fourth channel.

Optionally, the first slot is located at an end portion of the housing in the longitudinal direction and extends from the second divider through an end wall of the housing at the end portion in the longitudinal direction.

Optionally, the third channel and the fourth channel are disposed in the longitudinal direction closer to the end wall than the second divider.

Optionally, the third channel and the fourth channel are aligned with each other in the vertical direction.

Optionally, the plurality of first conductive elements comprises a pair of first conductive elements, one first conductive element of the pair of first conductive elements at least partially extends in the third channel, and the other first conductive element at least partially extends in the fourth channel.

Optionally, the third wall segment comprises a third inner surface facing towards the first slot and a third outer surface facing away from the first slot, the fourth wall segment comprises a fourth inner surface facing towards the first slot and a fourth outer surface facing away from the first slot, the third channel extends from the third inner surface into the third wall segment in the vertical direction, the fourth channel extends from the fourth inner surface into the fourth wall segment in the vertical direction, the third outer surface and the fourth outer surface are planar surfaces.

Optionally, for each first conductive element: the mating end of the first conductive element comprises a plurality of third contact fingers each having a mating contact portion disposed in the first slot; at least a portion of the intermediate portion of the first conductive element is disposed in a corresponding one of the third channel and the fourth channel; and each of the plurality of third contact fingers comprises a straight segment, a curved segment, and a contact segment, the straight segment extends from the intermediate portion towards the mating face in the lateral direction in the corresponding channel, the curved segment is joined between the straight segment and the contact segment, the contact segment extends from the curved segment away from the mating face and into the first slot in the lateral direction, the mating contact segment is on the contact segment.

Optionally, for each first conductive element: the mating contact portions of the plurality of third contact fingers are aligned with and spaced apart from each other in the longitudinal direction, and the contact surfaces of the mating contact portions of the plurality of third contact fingers are coplanar with each other.

Optionally, the straight segments of the plurality of third contact fingers are aligned with and spaced apart from each other in the longitudinal direction.

Optionally, the straight segment, the curved segment and the contact segment of each third contact finger have the same widths as each other in the longitudinal direction.

Optionally, the plurality of third contact fingers are aligned with each other in the longitudinal direction, and cross-sectional profiles of the plurality of third contact fingers perpendicular to the longitudinal direction are the same as each other.

Optionally, the first conductive element is formed from a single piece of conductive material.

Optionally, the number of the plurality of third contact fingers is at least eight.

Optionally, the electrical connector is configured to establish a separable electrical connection with a circuit board comprising an insert portion configured to be inserted into the first slot, the insert portion comprises a plurality of contiguous conductive regions, the mating contact portions of the plurality of third contact fingers of the first conductive element are configured to establish an electrical connection with a corresponding one of the plurality of contiguous conductive regions of the insert portion of the circuit board when the insert portion is inserted into the first slot.

Optionally, the housing further comprises a fourth slot, a fifth slot, and a sixth slot each recessed into the housing from the mating face in the lateral direction, the first slot, the second slot, the third slot, the fourth slot, the fifth slot, and the sixth slot are sequentially arranged and separated from each another by a corresponding one of a plurality of dividers of the housing in the longitudinal direction; and the plurality of conductive elements of the electrical connector further comprise: a plurality of fifth conductive elements, the mating contact portions of the mating ends of the plurality of fifth conductive elements are disposed in the fourth slot, and at least a portion of the plurality of fifth conductive elements are configured for transmitting signals; a plurality of sixth conductive elements, the mating contact portions of the mating ends of the plurality of sixth conductive elements are disposed in the fifth slot, and at least a portion of the plurality of sixth conductive elements are configured for transmitting signals; and a plurality of seventh conductive elements, the mating contact portions of the mating ends of the plurality of seventh conductive elements are disposed in the sixth slot, and at least a portion of the plurality of seventh conductive elements are configured for transmitting signals.

Optionally, the electrical connector comprises at least one terminal assembly disposed in the housing, each of the at least one terminal assembly comprises: at least some conductive elements of a corresponding one of (i) the plurality of second conductive elements, (ii) the plurality of fourth conductive elements, (iii) the plurality of fifth conductive elements, (iv) the plurality of sixth conductive elements, and (iv) the plurality of seventh conductive elements, the intermediate portion of each of the at least some conductive elements comprises a first segment and a second segment, the first segment is closer to the mating end than the second segment, the at least some conductive elements comprise a plurality of signal terminals and a plurality of ground terminals; an assembly housing disposed around the second segments of the intermediate portions of the at least some conductive elements to retain the at least some conductive elements in the housing, so that the at least some conductive elements are arranged in a row in the longitudinal direction, and so that the first segments of the intermediate portions and the mating ends of the at least some conductive elements are disposed outside of the assembly housing and are oriented in the lateral direction; and a shielding member comprising a body disposed on the assembly housing and a plurality of extensions each extending from the body beyond the assembly housing in the lateral direction and above the first segments of the intermediate portions of a corresponding group of signal terminals of the plurality of signal terminals.

Some embodiments relate to a terminal assembly for an electrical connector. The terminal assembly may comprises: a plurality of conductive elements each comprising a mating end, a contact tail opposite to the mating end, and an intermediate portion extending between the mating end and the contact tail, the intermediate portion comprising a first segment and a second segment, the first segment closer to the mating end than the second segment, the plurality of conductive elements comprising a plurality of signal terminals and a plurality of ground terminals; an assembly housing disposed around the second segments of the intermediate portions of the plurality of conductive elements to retain the plurality of conductive elements, so that the plurality of conductive elements are arranged in a row in a longitudinal direction, and so that the first segments of the intermediate portions and the mating ends of the plurality of conductive elements are disposed outside of the assembly housing and oriented in a lateral direction perpendicular to the longitudinal direction; and a shielding member comprising a body disposed on the assembly housing and a plurality of extensions each extending from the body beyond the assembly housing in the lateral direction and above the first segments of the intermediate portions of a corresponding group of signal terminals of the plurality of signal terminals.

Optionally, the plurality of extensions are spaced apart from the first segments of the intermediate portions of the plurality of conductive elements in a vertical direction perpendicular to the longitudinal direction and the lateral direction.

Optionally, the second segments of the intermediate portions of the plurality of conductive elements extend in the lateral direction and are aligned with each other in the longitudinal direction, the second segments collectively define a plane perpendicular to the vertical direction; the plurality of extensions extend parallelly to the plane on a first side of the plane; and the first segments of the intermediate portions of the plurality of conductive elements extend obliquely from the second segments away from the plane to a second side of the plane opposite to the first side.

Optionally, the plurality of signal terminals are arranged in a plurality of groups of signal terminals spaced apart in the longitudinal direction, and a ground terminal is disposed between two adjacent ones of the plurality of groups of signal terminals; and each of the plurality of extensions is located above the first segments of the intermediate portions of a corresponding one of the plurality of groups of signal terminals in the vertical direction, and does not extend above a ground terminal adjacent to the corresponding group of signal terminals.

Optionally, the assembly housing comprises a first surface and a plurality of recesses, each of the plurality of recesses is recessed into the assembly housing from the first surface in a vertical direction perpendicular to the longitudinal direction and the lateral direction so as to expose at least a portion of the second segment of a corresponding one of the plurality of ground terminals; and the body of the shielding member comprises a plurality of plateaus, a plurality of valleys, and connecting portions joining adjacent plateaus and valleys, the plurality of plateaus are disposed on the first surface, each valley and the corresponding connecting portions are received in a corresponding one of the plurality of recesses, and the valley is electrically coupled to at least a portion of the second segment of the corresponding ground terminal exposed by the corresponding recess.

Optionally, the plurality of signal terminals are arranged in a plurality of groups of signal terminals spaced apart from each other in the longitudinal direction, and a ground terminal is disposed between adjacent two of the plurality of groups of signal terminals; and each of the plurality of plateaus is disposed above the second segments of the intermediate portions of a corresponding one of the plurality of groups of signal terminals in the vertical direction, and is spaced apart from the second segments of the intermediate portions of the corresponding group of signal terminals by the assembly housing, each of the plurality of extensions extends from a corresponding one of the plurality of plateaus in the lateral direction and above the first segments of the intermediate portions of the group of signal terminals corresponding to the corresponding plateau.

Optionally, for each group of the plurality of groups of signal terminals: the second segments of the intermediate portions of the signal terminals are spaced apart from the corresponding plateau by a first distance in the vertical direction; a center of the second segment of the intermediate portion of the signal terminal is spaced from an edge of the second segment of the intermediate portion of the corresponding adjacent ground terminal by a second distance in the longitudinal direction; and the first distance is smaller than or equal to the second distance.

Optionally, each of the plurality of plateaus comprises an opening extending through the plateau in the vertical direction, the opening is aligned with the second segments of the intermediate portions of the corresponding group of signal terminals in the vertical direction.

Optionally, the assembly housing further comprises a plurality of protrusions protruding from the first surface in the vertical direction, each of the plurality of protrusions extends through the opening of a corresponding one of the plurality of plateaus.

Optionally, the extended range of the body of the shielding member in the longitudinal direction covers the second segments of the intermediate portions of the plurality of signal terminals and the plurality of ground terminals.

Optionally, the extended range of the body of the shielding member in the lateral direction covers at least portions of the second segments of the intermediate portions of the plurality of signal terminals and the plurality of ground terminals.

Optionally, for each of the plurality of conductive elements, the first segment joins the second segment and the mating end, each of the plurality of extensions extends in the lateral direction from the corresponding plateau to a position above the joints of the mating ends and the first segments of the intermediate portions of the group of signal terminals corresponding to the corresponding plateau.

Optionally, the valley is in direct contact with the at least a portion of the second segment of the corresponding ground terminal exposed by the corresponding recess, and the direct contact is a surface contact.

Optionally, the valley is attached on at least the portion of the second segment of the corresponding ground terminal exposed by the corresponding recess.

Optionally, the assembly housing is a member overmolded on the second segments of the intermediate portions of the plurality of conductive elements.

Some embodiments relate to an electrical connector. The electrical connector may comprises: a housing comprising a mating face and a slot recessed into the housing from the mating face; and the aforementioned terminal assembly, the terminal assembly disposed in the housing so that the mating contact portions of the mating ends of the plurality of conductive elements are disposed in the slot of the housing.

These techniques can be used individually or in any suitable combination. The preceding summary is provided by way of illustration and is not meant to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, front perspective view of an electronic system including a circuit board and an electrical connector, according to some embodiments;

FIG. 1B is a bottom, front perspective view of the electronic system of FIG. 1A;

FIG. 1C is a partially exploded view of the electronic system of FIG. 1A, with a rear member of the electrical connector hidden;

FIG. 1D is a partially exploded view of the electronic system of FIG. 1B, with the rear member of the electrical connector hidden;

FIG. 2A is a top, front perspective view of the electrical connector of the electronic system of FIG. 1C;

FIG. 2B is an enlarged perspective view of the electrical connector of FIG. 2A within a dashed box marked “2B” in FIG. 2A;

FIG. 2C is a bottom, front perspective view of the electrical connector of FIG. 2A;

FIG. 2D is an enlarged perspective view of the electrical connector of FIG. 2C within a dashed box marked “2D” in FIG. 2C;

FIG. 2E is a front view of the electrical connector of FIG. 2A;

FIG. 2F is an enlarged view of the electrical connector of FIG. 2E within a dashed box marked “2F” in FIG. 2E;

FIG. 2G is a top, rear perspective view of the electrical connector of FIG. 2A;

FIG. 2H is a bottom, rear perspective view of the electrical connector of FIG. 2A;

FIG. 2I is a partially exploded view of the electrical connector of FIG. 2A;

FIG. 3A is a partial cross-sectional view of the electrical connector of FIG. 2A in a lateral direction taken along a line marked “3A-3A” in FIG. 2E, with cables of the electrical connector hidden;

FIG. 3B is a cross-sectional view of the electrical connector of FIG. 2A taken along a line marked “3B-3B” in FIG. 2F, with the cables of the electrical connector hidden;

FIG. 3C is a cross-sectional view of the electrical connector taken along a line marked “3C-3C” in FIG. 2F, with the cables of the electrical connector hidden;

FIG. 3D is a cross-sectional view of the electrical connector taken along a line marked “3D-3D” in FIG. 2F with the cables of the electrical connector hidden;

FIG. 3E is a cross-sectional view of the electrical connector taken along a line marked “3E-3E” in FIG. 2F with the cables of the electrical connector hidden;

FIG. 3F is a cross-sectional view of the electrical connector taken along a line marked “3F-3F” in FIG. 2F, with the cables of the electrical connector hidden;

FIG. 4A is a perspective view of a housing of the electrical connector of FIG. 2A;

FIG. 4B is an enlarged perspective view of the housing of FIG. 4A within a dashed box marked “4B” in FIG. 4A;

FIG. 4C is a rear perspective view of the housing of FIG. 4A;

FIG. 4D is a side, front perspective view of the housing of FIG. 4A;

FIG. 4E is an enlarged perspective view of the housing of FIG. 4A within a dashed box marked “4E” in FIG. 4D;

FIG. 5A is a top, side perspective view of a pair of third conductive elements of the electrical connector of FIG. 2A, showing the relative positional relationship of the third conductive elements when disposed in the housing;

FIG. 5B is a bottom, side perspective view of the pair of third conductive elements of FIG. 5A;

FIG. 6A is a top, side perspective view of one third conductive element of the pair of third conductive elements of FIG. 5A;

FIG. 6B is a bottom, side perspective view of the third conductive element of FIG. 6A;

FIG. 6C is a bottom view of the third conductive element of FIG. 6A;

FIG. 6D is a top view of the third conductive element of FIG. 6A;

FIG. 7A is a top, front perspective view of two terminal assemblies of the electrical connector of FIG. 2A disposed in a third slot of the housing, looking front a right side, showing the relative positional relationship of the two terminal assemblies when disposed in the housing, and wherein the cables are hidden;

FIG. 7B is a top, front perspective view of the two terminal assemblies of FIG. 7A, looking from a left side;

FIG. 8A is a top perspective view of one of the two terminal assemblies of FIG. 7A, the terminal assembly comprising an assembly housing, a shielding member, fourth conductive elements, and a spacer;

FIG. 8B is a bottom perspective view of the terminal assembly of FIG. 8A;

FIG. 8C is a partially exploded perspective view of the terminal assembly of FIG. 8A;

FIG. 9A is a top perspective view of a shielding member of the terminal assembly of FIG. 8A;

FIG. 9B is a bottom perspective view of the shielding member of FIG. 9A;

FIG. 10A is a top perspective view of fourth conductive elements of the terminal assembly of FIG. 8A, showing the relative positional relationship of the fourth conductive elements when held by the assembly housing;

FIG. 10B is a bottom perspective view of the fourth conductive elements of FIG. 10A;

FIG. 10C is a top view of the fourth conductive elements of FIG. 10A;

FIG. 11 is a front view of the terminal assembly of FIG. 8A, with the assembly housing and the spacer of the terminal assembly hidden and showing the relative positional relationship between the shielding member and the fourth conductive elements;

FIG. 12 is a perspective view of a pair of first conductive elements of the electrical connector of FIG. 2A, showing the relative positional relationship of the first conductive elements when disposed in the housing;

FIG. 13A is a top perspective view of one first conductive element of the pair of first conductive elements of FIG. 12;

FIG. 13B is a bottom perspective view of the first conductive element of FIG. 13A;

FIG. 13C is a top view of the first conductive element of FIG. 13A; and

FIG. 13D is a bottom view of the first conductive element of FIG. 13A.

### DETAILED DESCRIPTION

The inventors have recognized and appreciated techniques for making high-speed, high bandwidth, and high-power card edge connectors. The inventors have recognized and appreciated techniques for increasing the operating speed through a large interface, such as a Pluggable Multi-Purpose Module (PMM) according to SFF-TA-1037. According to aspects of the present disclosure, a connector can be configured to receive a circuit board's edge portion that has multiple insertion portions separated from each other by notches. The connector may include multiple slots, each of which may be configured to receive a respective insertion portion. A first slot may provide access to power conductors. A second slot may provide access to both power and signal conductors. The other slots may provide access to signal conductors. The signal conductors can be configured to provide high-speed signal transmission (e.g., 112 GT/s with PAM4) or sideband signal transmission. The power conductors can be configured to provide high-power transmission (e.g., 200 W), enabling support for more power-hungry devices like AI accelerators, storage controllers, or networking modules. The connector housing may be mounted to a panel of an electric device such that the slots are accessible through the panel. The signal and the power conductors may be configured for direct cable connections, enabling the use of high-speed cables in a simple and cost-effective manner.

In some embodiments, a connector housing may include a mating face and a first slot, a second slot, and a third slot each recessed into the housing from the mating face in a lateral direction. The first slot, the second slot, and the third slot may be aligned in a longitudinal direction perpendicular to the lateral direction. A plurality of conductive elements may be held by the housing. Each conductive element may include a mating end having a mating contact portion, a contact tail configured for cable termination, and an intermediate portion joining the mating end and the contact tail.

The conductive elements disposed in the housing may include a plurality of first conductive elements, a plurality of second conductive elements, and a plurality of third conductive elements. The mating contact portions of the mating ends of the plurality of first conductive elements may be disposed in the first slot, and the plurality of first conductive elements may be configured for transmitting power. The mating contact portions of the mating ends of the plurality of second conductive elements may be disposed in the second slot, and at least a portion of the plurality of second conductive elements may be configured for transmitting signals. Such signals may include high-speed signals, such as differential signals. The mating contact portions of the mating ends of the plurality of third conductive elements may be disposed in the third slot, and the plurality of third conductive elements may be configured for transmitting power.

The second slot and the third slot of the housing may be separated by a first divider of the housing. The third slot may be bound by a first wall segment and a second wall segment of the housing in the vertical direction. First and second channels may be adjacent to the first divider and extend from the third slot into the first wall segment and the second wall segment, respectively, in the vertical direction. The plurality of third conductive elements may at least partially extend in the first channel and the second channel.

The plurality of conductive elements of the electrical connector may comprise a plurality of fourth conductive elements. Mating contact portions of mating ends of the plurality of fourth conductive elements may be disposed in the third slot, and at least a portion of the plurality of fourth conductive elements may be configured for transmitting signals. The plurality of third conductive elements may be disposed closer to the first divider in the longitudinal direction than the plurality of fourth conductive elements.

The second slot and the first slot of the housing may be separated by a second divider of the housing. The first slot may be bound by a third wall segment and a fourth wall segment of the housing in the vertical direction. The third channel and the fourth channel may extend from the first slot into the third wall segment and the fourth wall segment in the vertical direction, respectively. The plurality of first conductive elements may at least partially extend in the third channel and the fourth channel.

According to aspects of the present disclosure, conductive elements for different purposes can be integrated into an electrical connector to enable the electrical connector to provide both signal transmission and power transmission. For example, the electrical connector can provide high-speed signal transmission and high-power transmission in a high-density configuration. Further, conductive elements (for example, the first conductive element and the third conductive elements) with a larger dimension and/or a larger pitch can be disposed in the electrical connector without the need to add an additional slot or to add an additional electrical connector to the electronic system. Furthermore, such a configuration enables the electrical connector to be backward compatible with add-in cards designed and manufactured according to specific specifications, such as those (for example, pluggable multi-purpose modules (PMMs)) designed and manufactured according to the current version of SFF-TA-1037. Such add-in cards, for example, were originally designed to require mate with multiple electrical connectors. With the configuration described above, the electrical connector can integrate the functions of the plurality of electrical connectors so as to mate with such add-in cards. In this way, the number of components of the electronic system can be reduced, thereby increasing the integration and the manufacturing and assembly efficiency of the electronic system.

In some embodiments, the electrical connector may include a terminal assembly having a plurality of conductive elements. The plurality of conductive elements may each include a mating end, a contact tail opposite to the mating end, and an intermediate portion extending between the mating end and the contact tail. The intermediate portion of each conductive element may include a first segment and a second segment. The first segment may be closer to the mating end than the second segment. The plurality of conductive elements may include a plurality of signal terminals and a plurality of ground terminals. The terminal assembly may further include an assembly housing disposed around the second segments of the intermediate portions of the plurality of conductive elements to retain the plurality of conductive elements, so that the plurality of conductive elements are arranged in a row in the longitudinal direction, and so that the first segments of the intermediate portions and the mating ends of the plurality of conductive elements are disposed outside of the assembly housing and are oriented in a lateral direction perpendicular to the longitudinal direction. The terminal assembly may further include a shielding member having a body and a plurality of extensions. The body of the shielding member is disposed on the assembly housing, and each of the plurality of extensions extends out of the body beyond the assembly housing in the lateral direction, and extends above the first segments of the intermediate portions of a corresponding group of the plurality of signal terminals. With such a configuration, it is possible to provide shielding protection along the signal transmission path so as to improve signal integrity, thereby improving the signal transmission performance of the electrical connector.

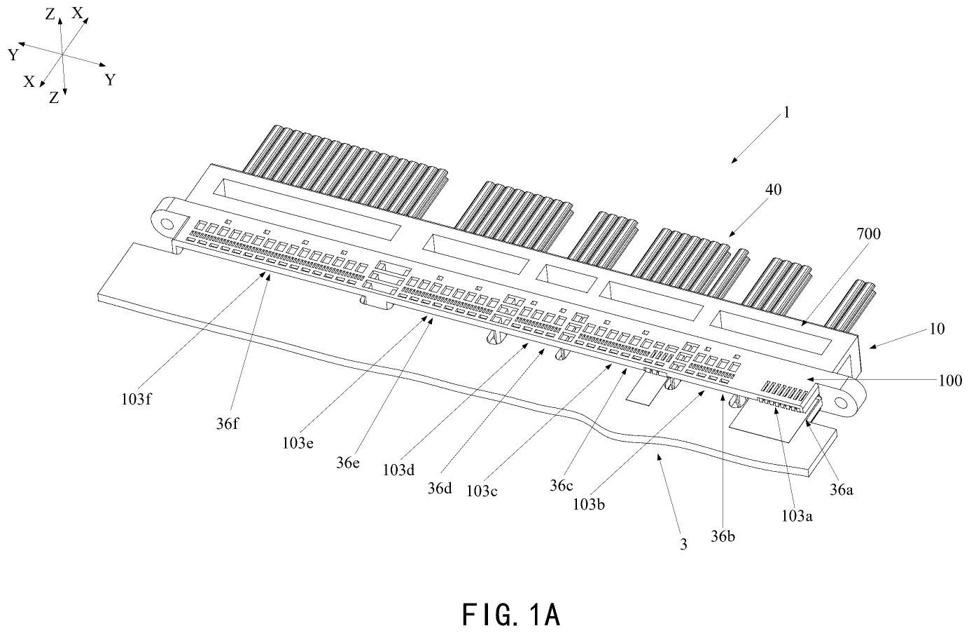

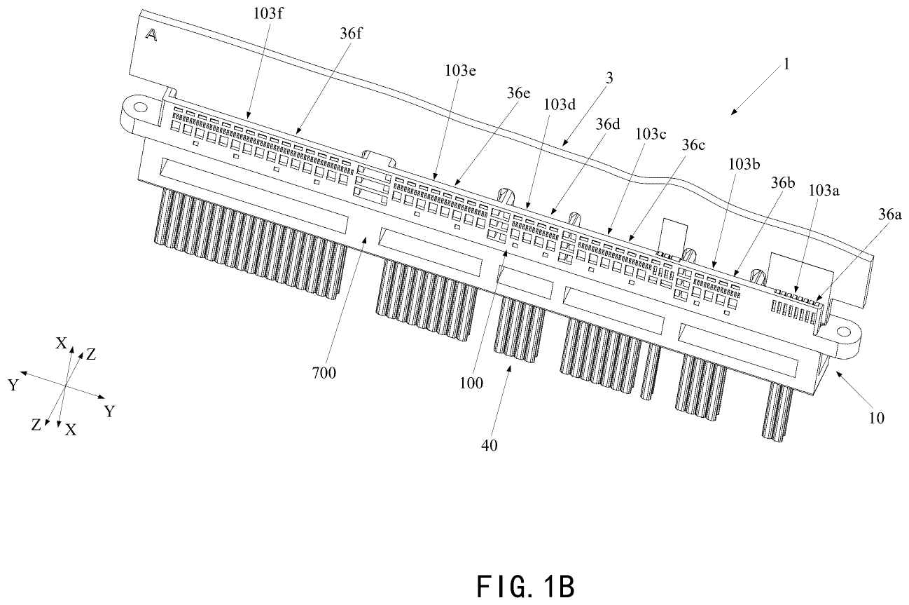

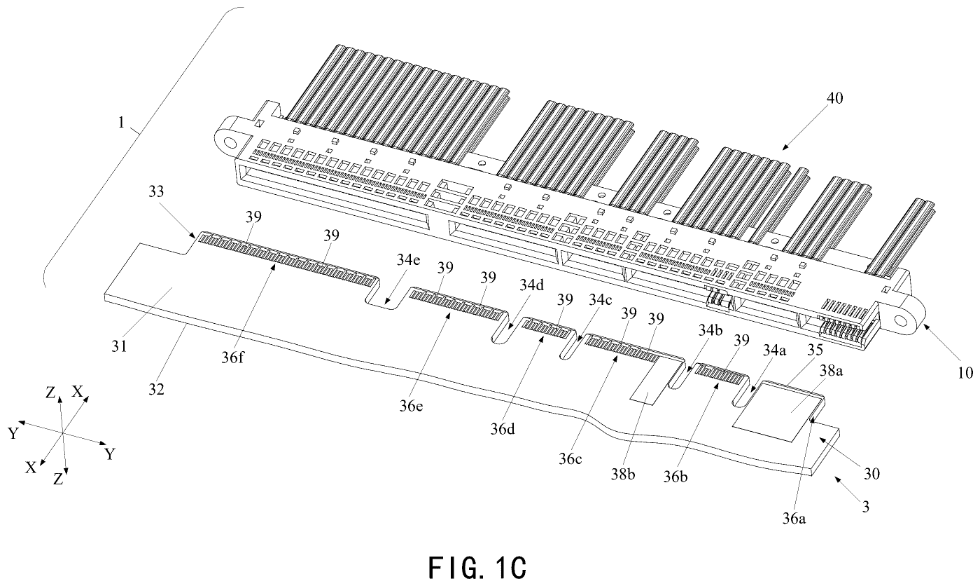

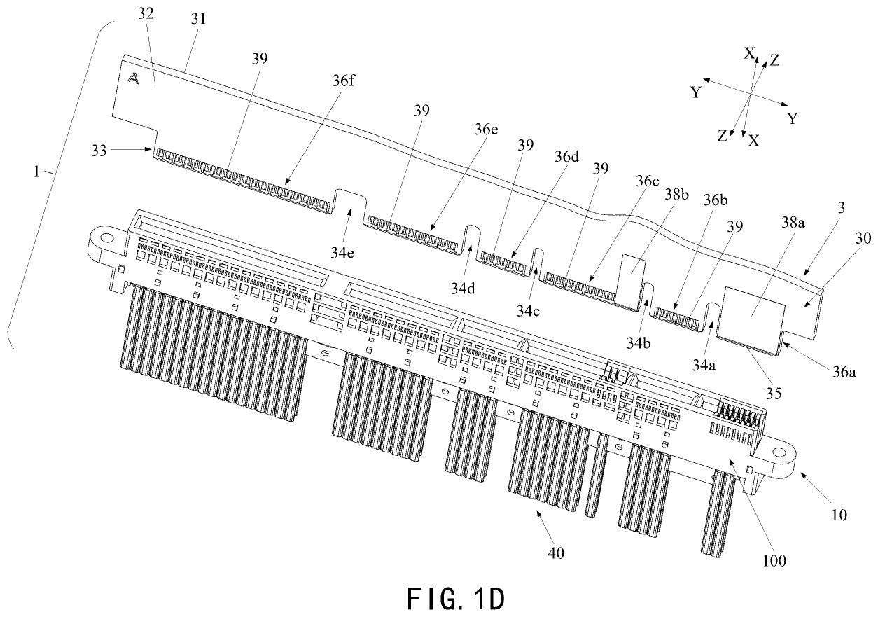

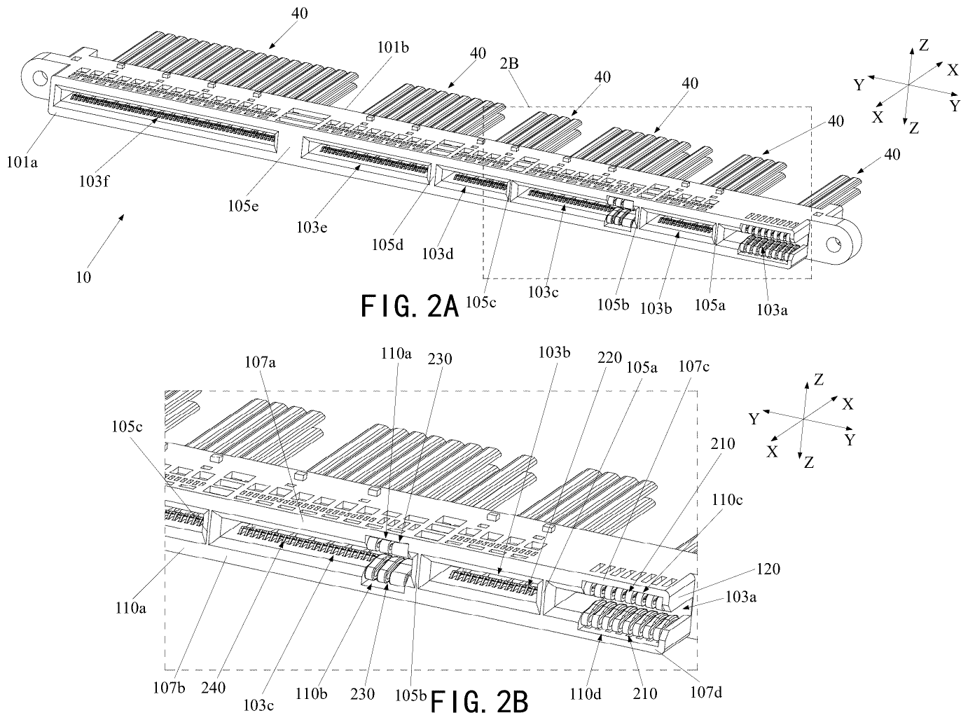

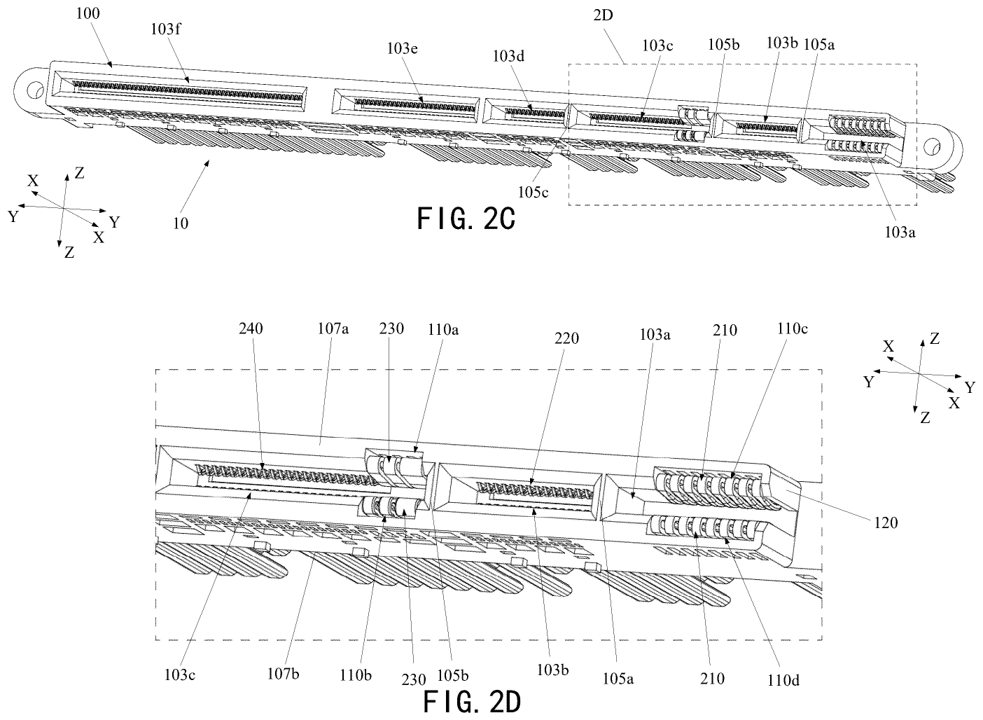

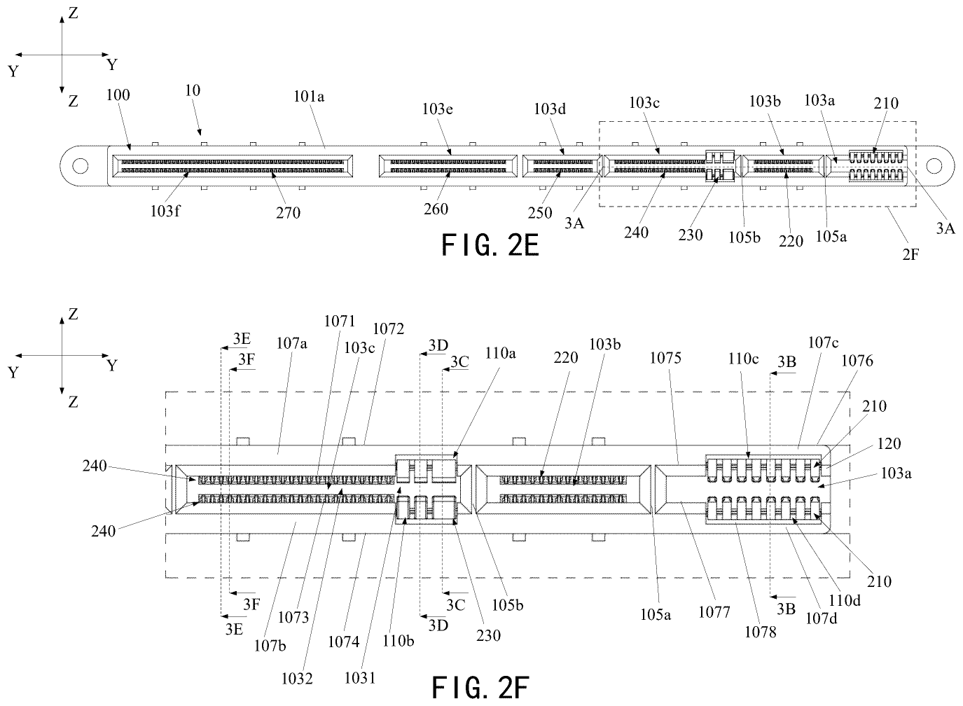

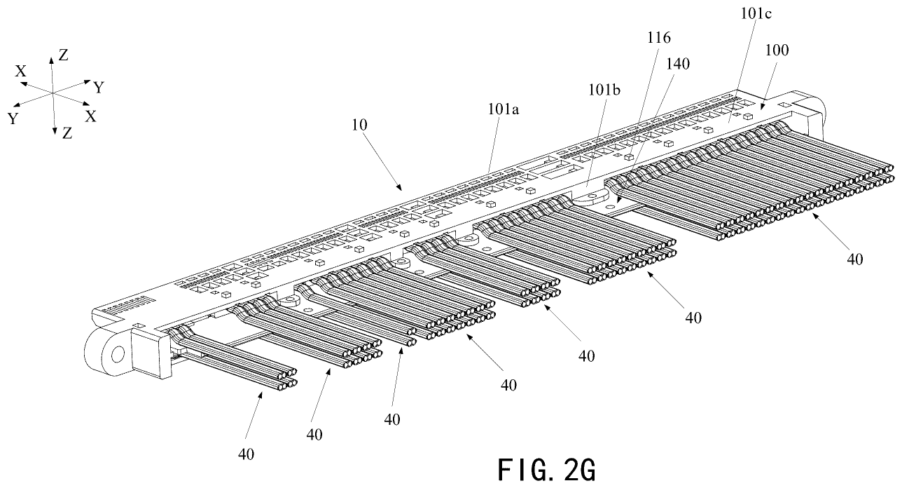

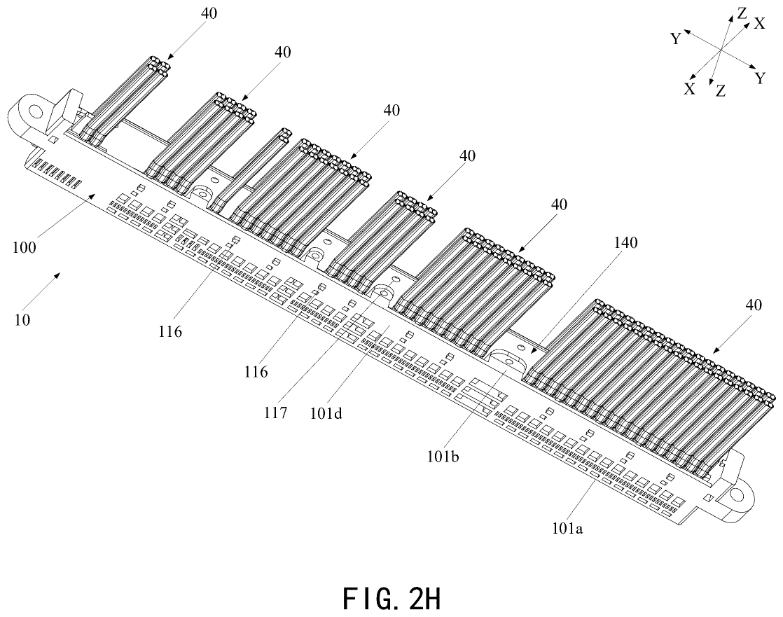

According to aspects of the present disclosure, FIGS. 1A to 1D illustrate an electronic system 1 including an electrical component 3 and an electrical connector 10. FIGS. 2A to 13D illustrate the electrical connector 10. For the sake of clarity and conciseness of description, a lateral direction X-X, a longitudinal direction Y-Y, and a vertical direction Z-Z may be shown in FIGS. 1A to 13D. The lateral direction X-X, the longitudinal direction Y-Y, and the vertical direction Z-Z may be perpendicular to each other. The lateral direction X-X may refer to a width direction of the electrical connector 10. The longitudinal direction Y-Y may refer to a length direction of the electrical connector 10. The vertical direction Z-Z may refer to a height direction of the electrical connector 10.

FIGS. 1A and 1B are perspective views illustrating the electronic system 1 in top-side and bottom-side views, respectively, and FIGS. 1C and 1D are partially exploded views illustrating the electronic system 1 in top-side and bottom-side views, respectively. As shown in FIGS. 1A to 1D, the electrical connector 10 is shown as a card edge type cable connector. The electrical connector 10 may be used to establish an electrical connection between the electrical component 3 and another electrical component (not shown). For example, the electrical component 3 may be an add-in card, such as a pluggable multi-purpose module (PMM), and the other electrical component may be another circuit board, such as a motherboard, or another electrical connector that may be mounted on another circuit board, such as a motherboard, or may be connected to a mating electrical connector mounted on another circuit board. In the illustrated example, the electrical connector 10 is configured to be mounted to a panel to provide a mating interface at the panel. As illustrated, a housing 100 of the electrical connector 10 comprises a pair of extensions disposed on opposite side of the housing in the longitudinal direction and configured for connecting to a panel. Each extension has a hole, which may receive a fastener extending through both the panel and the extension.

FIGS. 1C and 1D illustrate an exemplary electrical component 3. The electrical component 3 is labeled with a circuit board 30 in FIGS. 1C and 1D. It should be appreciated that only a part of the circuit board 30, rather than the entire circuit board 30, is shown in the drawings. The circuit board 30 may, for example, be configured for use in a high power application, such as an application with power up to 200 W or more. The circuit board 30 includes a first surface 31, a second surface 32, and a first end portion 33. The first surface 31 and the second surface 32 may be opposite to each other in the vertical direction Z-Z and substantially parallel to each other. The first end portion 33 of the circuit board 30 is configured to be inserted into a slot of the electrical connector 10. Notches 34a, 34b, 34c, 34d, and 34e are recessed into the circuit board 30 from an edge 35 at the first end portion 33 to separate the first end portion 33 into insert portions 36a, 36b, 36c, 36d, 36e, and 36f. As will be described below, the insert portions 36a-36f may be configured to be inserted into respective slots of the electrical connector 10.

The circuit board 30 may include a conductive portion provided at or near the edge 35 at each of the insert portions 36a-36f. For example, the conductive portion of the insert portion 36a may include a first conductive region 38a. The conductive portions of the insert portions 36b, 36d, 36c, and 36f may each include conductive pads 39 spaced apart from one another in the longitudinal direction Y-Y. The conductive portion of the insert portion 36b may include a second conductive region 38b and conductive pads 39 spaced apart from each other in the longitudinal direction Y-Y. The first conductive region 38a and the second conductive region 38b may each be continuous in the longitudinal direction Y-Y. At each of the insert portions 36a-36f, corresponding conductive portions may be provided on both the first surface 31 and the second surface 32 of the circuit board 30. For example, corresponding conductive portions may be provided on opposite sides of each of the insert portions 36a-36f. For example, the conductive portions on the first surface 31 and the second surface 32 of the circuit board 30 may be symmetrical about the circuit board 30. Alternatively, corresponding conductive portions may be provided on only one side of the insert portions 36a-36f.

FIGS. 2A to 13D illustrate the electrical connector 10. The electrical connector 10 may be a card edge cable connector. The electrical connector 10 may establish a separable electrical connection with the circuit board 30. For example, the insert portions 36a-36f of the circuit board 30 may be inserted into corresponding slots of the electrical connector 10, so that an electrical contact is established between the corresponding conductive portions of the insert portions 36a-36f and mating ends of corresponding conductive elements of the electrical connector 10. Contact tail of the conductive element of the electrical connector 10 may be attached with a cable 40 so as to be connected to the corresponding conductive portion of another electrical component via the cable 40. The other electrical component may be another circuit board, such as a motherboard, or another electrical connector, which may, for example, be mounted on another circuit board, such as a motherboard, or may be connected to a mating electrical connector mounted on another circuit board. In this way, an electrical connection can be established between the circuit board 30 and the other electrical component via the electrical connector 10.

The electrical connector 10 includes a housing 100 and conductive elements disposed in the housing 100. The housing 100 may be formed from an insulative material. Examples of insulative materials suitable for forming the housing 100 include, but are not limited to, plastic, nylon, liquid crystal polymer (LCP), polyphenylene sulfide (PPS), high temperature nylon or polyphenylene oxide (PPO) or polypropylene (PP). Each of the conductive elements may be formed from a conductive material. The conductive material suitable for forming the conductive element may be a metal or a metal alloy, such as a copper or a copper alloy.

As shown in FIGS. 2A to 2F, the housing 100 includes a first face 101a and a second face 101b opposite each other in the lateral direction X-X, and slots each recessed into the housing 100 from the first face 101a. For example, the housing 100 may include a first slot 103a, a second slot 103b, a third slot 103c, a fourth slot 103d, a fifth slot 103e, and a sixth slot 103f each recessed into the housing 100 from the first face 101a in the lateral direction X-X. The first face 101a may also be referred to as “a mating face”. For example, the electrical connector 10 may have six slots 103a-103f at the mating interface. The first slot 103a, the second slot 103b, the third slot 103c, the fourth slot 103d, the fifth slot 103e, and the sixth slot 103f are sequentially arranged and spaced apart from each other in the longitudinal direction Y-Y. For example, in the longitudinal direction Y-Y, the first slot 103a, the second slot 103b, the third slot 103c, the fourth slot 103d, the fifth slot 103c, and the sixth slot 103f are arranged in sequence. The first slot 103a, the second slot 103b, the third slot 103c, the fourth slot 103d, the fifth slot 103c, and the sixth slot 103f may each be elongated in the longitudinal direction Y-Y.

Every two adjacent slots of the first slot 103a, the second slot 103b, the third slot 103c, the fourth slot 103d, the fifth slot 103c, and the sixth slot 103f may be spaced apart by a corresponding one of the dividers of the housing 100 in the longitudinal direction Y-Y. For example, two adjacent slots are not in communication with each other. As shown in FIG. 2A, the first slot 103a and the second slot 103b are spaced apart by the divider 105a in the longitudinal direction Y-Y, the second slot 103b and the third slot 103c are spaced apart by the divider 105b in the longitudinal direction Y-Y, the third slot 103c and the fourth slot 103d are spaced apart by the divider 105c in the longitudinal direction Y-Y, the fourth slot 103d and the fifth slot 103e are spaced apart by the divider 105d in the longitudinal direction Y-Y, and the fifth slot 103e and the sixth slot 103f are spaced apart by the divider 105e in the longitudinal direction Y-Y. The dividers 105a-105e may be integral portions of the housing 100.

The insert portions 36a-36f of the circuit board 30 may be inserted into the first slot 103a, the second slot 103b, the third slot 103c, the fourth slot 103d, the fifth slot 103c, and the sixth slot 103f, respectively. The dividers 105a-105e may be used to guide the insertion of the insert portions 36a-36f of the circuit board 30 into the corresponding slots. For example, the dividers 105a-105e may be received in the notches 34a-34c of the circuit board 30, respectively, to guide the insertion of the insert portions 36a-36f of the circuit board 30 into the corresponding slots.

As shown in FIGS. 2E and 2I, the conductive elements of the electrical connector 10 includes first conductive elements 210 disposed in the housing 100 in correspondence with the first slot 103a, second conductive elements 220 disposed in the housing 100 in correspondence with the second slot 103b, third conductive elements 230 and fourth conductive elements 240 disposed in the housing 100 in correspondence with the third slot 103c, fifth conductive elements 250 disposed in the housing 100 in correspondence with the fourth slot 103d, sixth conductive elements 260 disposed in the housing 100 in correspondence with the fifth slot 103c, and seventh conductive elements 270 disposed in the housing 100 in correspondence with the sixth slot 103f.

As will be described below, each of the conductive elements of the electrical connector 10 includes a mating end having a mating contact portion, a contact tail opposite to the mating end, and an intermediate portion joining the mating end and the contact tail. The mating end may be configured to be mated with a corresponding conductive portion of an electrical component 3, such as the aforesaid circuit board 30. The contact tail may be configured to be attached with a corresponding cable 40. Each conductive element is held in the housing 100 so that the mating contact portion of the mating end extends into a corresponding slot to electrically contact the corresponding conductive portion of the circuit board 30.

Features of the electrical connector 10 are described below in connection with the first conductive elements 210 disposed in the first slot 103a, the second conductive elements 220 disposed in the second slot 103b, and the third conductive elements 230 and the fourth conductive elements 240 disposed in the third slot 103c.

In some embodiments, the first conductive elements 210 disposed in the first slot 103a may be configured for transmitting power, at least a portion of the second conductive elements 220 disposed in the second slot 103b may be configured for transmitting signals, and the third conductive elements 230 disposed in the third slot 103c may be configured for transmitting power. The signals may be high-speed signals, such as differential signals. With such a configuration, conductive elements for different purposes can be integrated into one and the same electrical connector 10 to enable the electrical connector 10 to provide both signal transmission and power transmission. For example, the electrical connector 10 can provide high-speed signal transmission and high-power transmission in a high-density configuration. Furthermore, such a configuration enables the electrical connector 10 to be backward compatible with add-in cards designed and manufactured according to specific specifications, such as those (for example, pluggable multi-purpose modules (PMMs)) designed and manufactured according to the current version of SFF-TA-1037. Such add-in cards, for example, were originally designed to require mate with multiple electrical connectors. With the configuration described above, the electrical connector 10 can integrate the functions of the electrical connectors so as to mate with such add-in cards. In this way, the number of components of the electronic system 1 can be reduced, thereby increasing the integration and the manufacturing and assembly efficiency of the electronic system 1.

As shown in FIGS. 2A to 2F and 2I, two third conductive elements 230 and the fourth conductive elements 240 at least partially extend in the third slot 103c. Although two third conductive elements 230 are shown in the drawings, it should be appreciated that only one third conductive element 230, or more than two third conductive elements 230, may be included in the third slot 103c. For example, one or more pairs of third conductive elements 230 may be included in the third slot 103c.

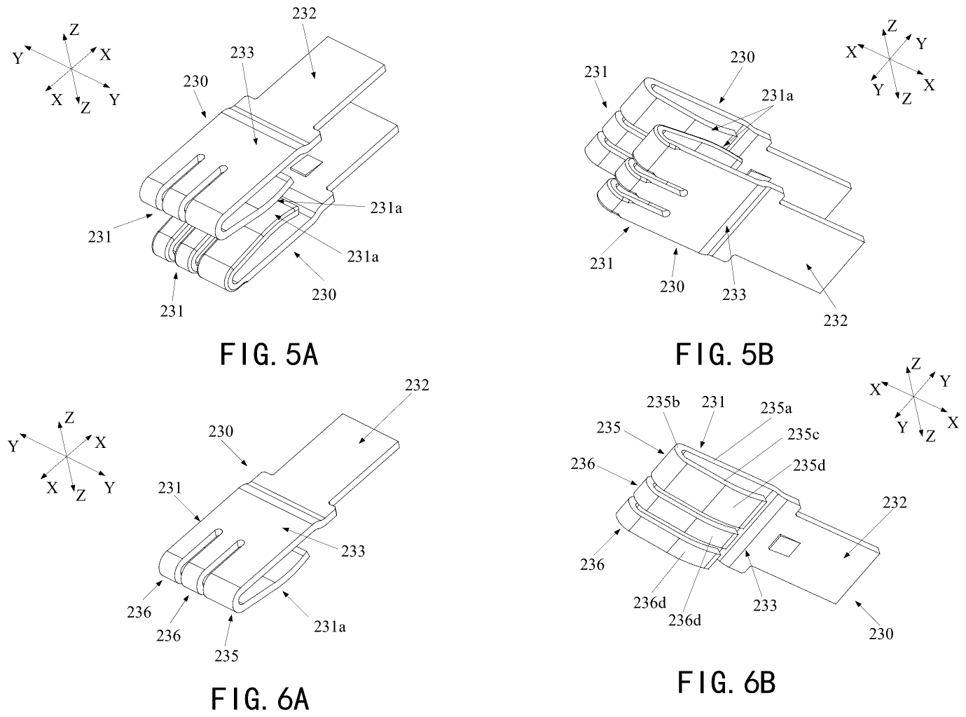

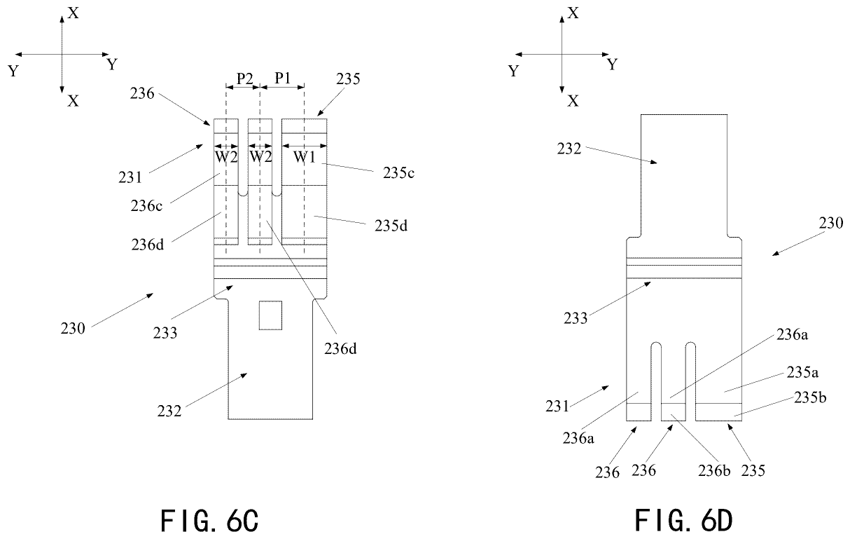

The third conductive elements 230 may be configured for transmitting power. Exemplary third conductive elements 230 are illustrated in FIGS. 5A to 6D. FIGS. 5A and 5B are perspective views illustrating the relative positional relationship of the two third conductive elements 230 when disposed in the housing 100. FIGS. 6A to 6D illustrate one of the third conductive elements 230.

As shown in FIGS. 5A to 6D, each third conductive element 230 includes a mating end 231 having a mating contact portion 231a, a contact tail 232 opposite to the mating end 231, and an intermediate portion 233 joining the mating end 231 and the contact tail 232. As will be described below, the mating end 231 of the third conductive element 230 may be configured to electrically contact a corresponding second conductive region 38b of the insert portion 36c of the circuit board 30. The contact tail 232 of the third conductive element 230 may be configured to attach with a corresponding cable 40.

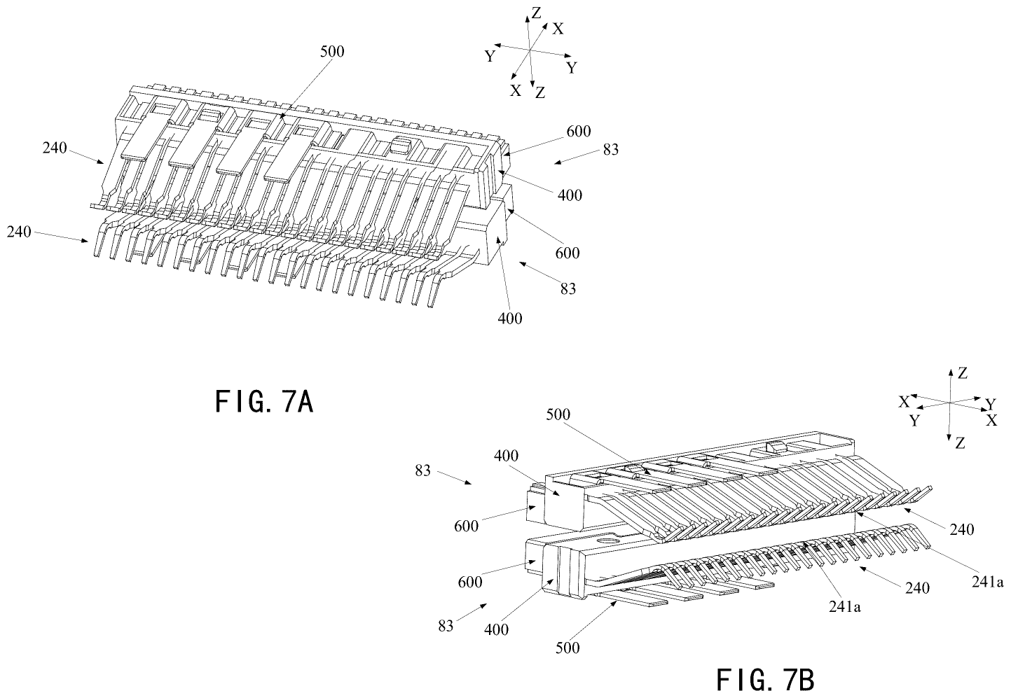

FIGS. 7A to 8C and 10A to 10C illustrate exemplary fourth conductive elements 240. Each fourth conductive element 240 includes a mating end 241 having a mating contact portion 241a, a contact tail 242 opposite to the mating end 241, and an intermediate portion 243 joining the mating end 241 and the contact tail 242. The mating end 241 of the fourth conductive element 240 may be configured to electrically contact the corresponding conductive pad 39 of the insert portion 36c of the circuit board 30. The contact tail 242 of the fourth conductive element 240 may be configured to attach with a corresponding cable 40.

As shown, the third conductive element 230 may have a larger dimension in the lateral direction X-X, the longitudinal direction Y-Y, and the vertical direction Z-Z, as compared to the fourth conductive element 240. Further, two third conductive elements 230 may be spaced apart from each other by a greater distance in the vertical direction Z-Z, as compared to the fourth conductive elements 240. In addition, as will be described below, the mating contact portions 231a of the third conductive elements 230 may be spaced center-to-center by a greater distance in the longitudinal direction Y-Y, as compared to the mating contact portions 241a of the fourth conductive elements 240.

It should be appreciated that the present application may not be limited thereto. For example, as compared to the fourth conductive element 240, the third conductive element 230 may have a larger dimension in only one and two of the lateral direction X-X, the longitudinal direction Y-Y, and the vertical direction Z-Z. As another example, there may be third conductive elements 230, and two adjacent third conductive elements 230 in the longitudinal direction Y-Y may be spaced apart from each other by a greater distance.

As shown in FIGS. 2B, 2D, and 2F, the housing 100 may include a first wall segment 107a and a second wall segment 107b spaced apart by the third slot 103c in the vertical direction Z-Z. For example, the first wall segment 107a and the second wall segment 107b of the housing 100 define the boundary of the third slot 103c in the vertical direction Z-Z. Further, the divider 105b and the divider 105c of the housing 100 define the boundary of the third slot 103c in the longitudinal direction Y-Y.

As shown in FIGS. 2B, 2D, and 2F, the housing 100 may include a first channel 110a and a second channel 110b. The first channel 110a and the second channel 110b may be adjacent to the divider 105b and extend from the third slot 103c into the first wall segment 107a and the second wall segment 107b in the vertical direction Z-Z, respectively, to accommodate the two third conductive elements 230. One of the two third conductive elements 230 at least partially extends in the first channel 110a, and the other one at least partially extends in the second channel 110b. The mating contact portions 231a of the mating ends 231 of the two third conductive elements 230 extend into the third slot 103c.

With such a configuration, the third conductive elements 230 can be disposed adjacent to the divider 105b of the housing 100 that separates the third slot 103c and the second slot 103b from each other, and can be disposed in one and the same slot as the fourth conductive elements 240. This enables the third conductive elements 230 with larger dimension and/or greater pitch to be disposed in the electrical connector 10, without having to add additional slots or to add additional electrical connectors to the electronic system 1. Such a configuration will not significantly increase the space occupied by the electrical connector 10. With such a configuration, conductive elements for different purposes can be integrated into one and the same electrical connector 10 to enable the electrical connector 10 to provide both signal transmission and power transmission. For example, the electrical connector 10 can provide high-speed signal transmission and high-power transmission in a high-density configuration. In addition, such a configuration enables the electrical connector 10 to be backward compatible with add-in cards designed and manufactured according to a particular specification, such as the add-in cards (for example, pluggable multi-purpose modules (PMMs)) designed and manufactured according to the current version of SFF-TA-1037. Such add-in cards, for example, were originally designed to require mate with multiple electrical connectors. With the configuration described above, the electrical connector 10 can integrate the functions of the electrical connectors so as to mate with such add-in cards. In this way, the number of components of the electronic system 1 can be reduced, thereby increasing the integration and the manufacturing and assembly efficiency of the electronic system 1.

As shown in FIG. 2F, the first wall segment 107a includes a first inner surface 1071 facing towards the third slot 103c and a first outer surface 1072 facing away from the third slot 103c, and the second wall segment 107b includes a second inner surface 1073 facing towards the third slot 103c and a second outer surface 1074 facing away from the third slot 103c. The first channel 110a extends into the first wall segment 107a from the first inner surface 1071 in the vertical direction Z-Z, and the second channel 110b extends from into the second wall segment 107b the second inner surface 1073 in the vertical direction Z-Z. In some embodiments, as shown in FIG. 2F, the first outer surface 1072 and the second outer surface 7074 may be planar surfaces.

In some other embodiments, a portion of the first wall segment 107a adjacent to the divider 105b may protrude outwardly away from the third slot 103c to form a first accommodation portion or protrusion (not shown), and the first channel 110a may extend into the first accommodation portion from the first inner surface 1071 in the vertical direction Z-Z. Alternatively or additionally, a portion of the second wall segment 107b adjacent to the divider 105b may protrude outwardly away from the third slot 103c to form a second accommodation portion or protrusion (not shown), and the second channel 110b may extend into the second accommodation portion from the second inner surface 1073 in the vertical direction Z-Z.

In some embodiments, as shown in FIG. 2F, the first channel 110a and the second channel 110b may be aligned with each other in the vertical direction Z-Z. It should be appreciated that the present application may not be limited thereto. In some other embodiments, the first channel 110a and the second channel 110b may be offset from each other in the vertical direction Z-Z.

The third conductive element 230 disposed in the first channel 110a may be referred to as “an upper third conductive element”, and the third conductive element 230 disposed in the second channel 110b may be referred to as “a lower third conductive element”. It should be appreciated that this only indicates a relative positional relationship, rather than an absolute positional relationship, between the two third conductive elements 230 when disposed in the housing 100. FIGS. 6A to 6D illustrate the upper third conductive element 230.

As shown in FIGS. 6A to 6D, the mating end 231 of the third conductive element 230 includes one first contact finger 235 and two second contact fingers 236. The one first contact finger 235 and the two second contact fingers 236 together form the mating end 231 of the third conductive element 230. The first contact finger 235 has a mating contact portion 235d to electrically contact the second conductive region 38b of the insert portion 36c of the circuit board 30, and each of the second contact fingers 236 has a mating contact portion 236d to electrically contact the second conductive region 38b of the insert portion 36c of the circuit board 30. In this case, the mating end 231 of the third conductive element 230 may have three mating contact portions, e.g., one mating contact portion 235d and two mating contact portions 236d. When the third conductive element 230 is disposed in the housing 100, the one first contact finger 235 is closer to the divider 105b of the housing 100 in the longitudinal direction Y-Y than the two second contact fingers 236. The three mating contact portions of the mating end 231 of the third conductive element 230 may be configured to electrically contact the second conductive region 38b (e.g., one and the same continuous conductive region) of the insert portion 36c of the circuit board 30.

As shown in FIG. 6C, the mating contact portion 235d of the first contact finger 235 of the third conductive element 230 has a width W1 in the longitudinal direction Y-Y, and the mating contact portion 236d of each of the two second contact fingers 236 has a width W2 in the longitudinal direction. The width W1 is greater than the width W2. The width W1 may be at least 1.5 times the width W2. For example, the width W1 may be 1.5 times, 1.6 times, 1.8 times, or twice the width W2. When the third conductive element 230 is used for transmitting power, due to such configurations of the first contact finger 235 and the second contact fingers 236, the current flowing through the first contact finger 235 is greater than the current flowing through each of the second contact fingers 236.

As shown in FIGS. 6A and 6B, the first contact finger 235 and the two second contact fingers 236 of the third conductive element 230 may be aligned with and spaced apart from each other in the longitudinal direction Y-Y. As shown in FIG. 6C, the mating contact portion 235d of the first contact finger 235 and the mating contact portion 236d of the second contact finger 236, adjacent to the first contact finger 235, of the third conductive element 230 are spaced center-to-center from each other by a pitch P1 in the longitudinal direction Y-Y, and the mating contact portions 236d of the two second contact fingers 236 are spaced center-to-center from each other by a pitch P2 in the longitudinal direction Y-Y. The pitch P1 is greater than the pitch P2.

As shown in FIGS. 5A and 5B, the two third conductive elements 230 (e.g., the upper third conductive element and the lower third conductive element) are symmetrical to each other about an imaginary plane parallel to the lateral direction X-X and the longitudinal direction Y-Y. For example, the lower third conductive element and the upper third conductive element are symmetrical to each other. The lower third conductive element may be configured similar to the upper third conductive elements.

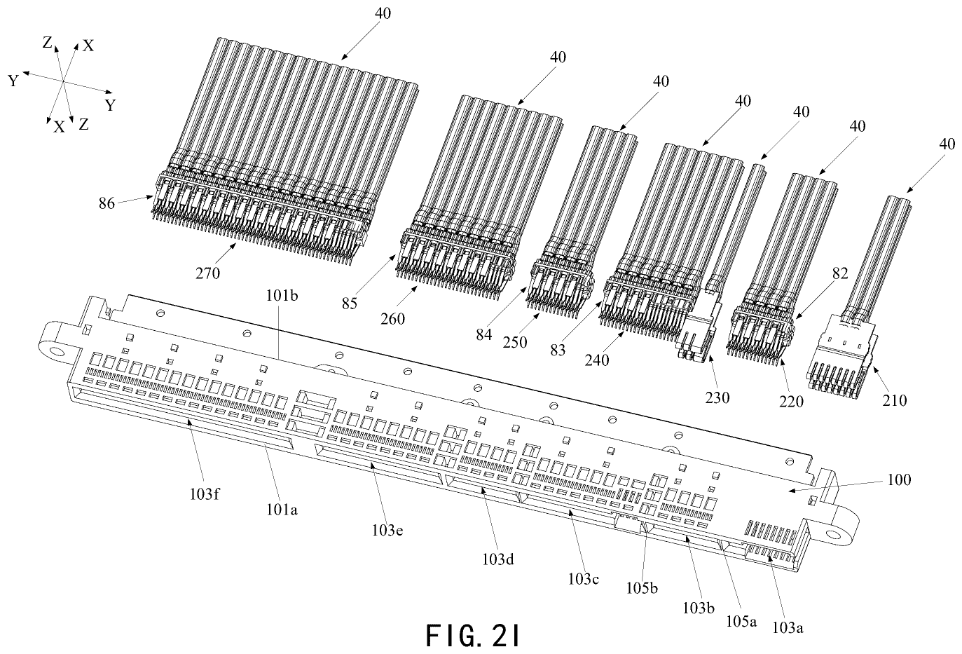

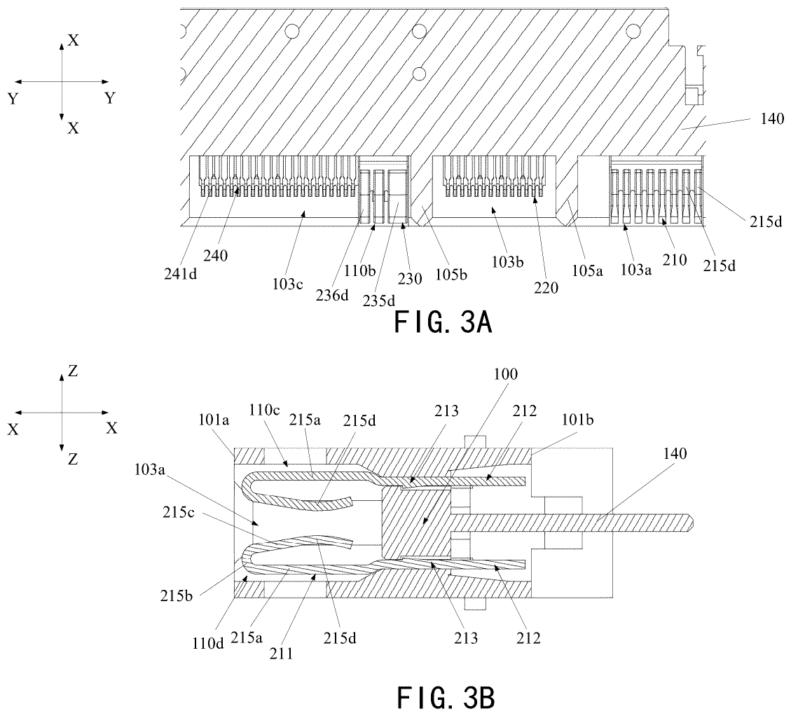

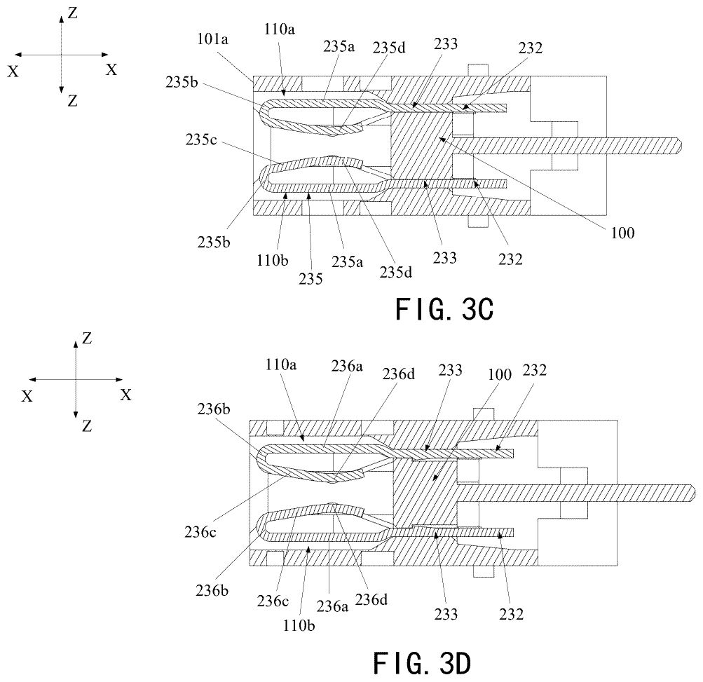

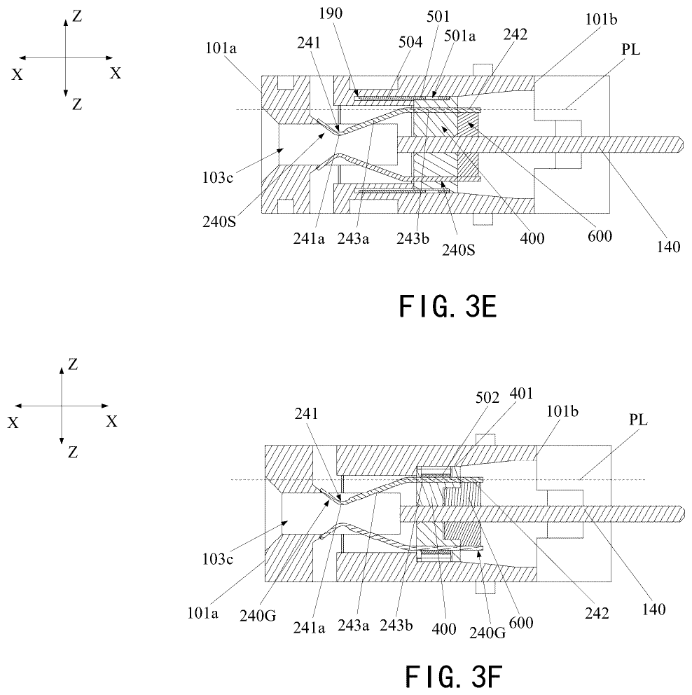

In some embodiments, as shown in FIGS. 3C and 3D, at least a portion of the intermediate portion 233 of each of the two third conductive elements 230 may be disposed in a corresponding one of the first channel 110a and the second channel 110b. As shown in FIGS. 3C to 3D and 5A to 6B, for each third conductive element 230, the first contact finger 235 may include a straight segment 235a, a curved segment 235b, and a contact segment 235c. The straight segment 235a extends from the intermediate portion 233 towards the first face 101a in the lateral direction X-X in the corresponding channel, the curved segment 235b is joined between the straight segment 235a and the contact segment 235c, the contact segment 235c extends from the curved segment 235b away from the first face 101a in the lateral direction X-X and into the third slot 103c, and the mating contact portion 235d is on the contact segment 235c. Each of the two second contact fingers 236 may include a straight segment 236a, a curved segment 236b, and a contact segment 236c. For each second contact finger 236, the straight segment 236a extends from the intermediate portion 233 towards the first face 101a in the lateral direction X-X in the corresponding channel, the curved segment 236b is joined between the straight segment 236a and the contact segment 236c, the contact segment 236c extends from the curved segment 236b away from the first face 101a in the lateral direction X-X and into the third slot 103c, and the mating contact portion 236d is on the contact segment 236c.

In some embodiments, as shown in FIGS. 5A to 6B, for each third conductive element 230, the mating contact portion 235d of the one first contact finger 235 and the two mating contact portions 236d of the two second contact fingers 236 may be aligned with and spaced apart from each other in the longitudinal direction Y-Y. The contact surface of the mating contact portion 235d of the one first contact finger 235 and the contact surfaces of the two mating contact portions 236d of the two second contact fingers 236 may be coplanar with each other.

In some embodiments, as shown in FIGS. 5A to 6B, for each third conductive element 230, the straight segment 235a of the one first contact finger 235 and the two straight segments 236a of the two second contact fingers 236 may be aligned with and spaced apart from each other in the longitudinal direction Y-Y.

In some embodiments, the first contact fingers 235 of the two third conductive elements 230 may be aligned with each other in the vertical direction Z-Z (as shown in FIGS. 2F and 3C), or may be offset from each other. In some embodiments, the second contact fingers 236 of the two third conductive elements 230 may be aligned with each other in the vertical direction Z-Z (as shown in FIGS. 2F and 3D), or may be offset from each other.

In some embodiments, as shown in FIGS. 5A to 6D, for each third conductive element 230, the straight segment 235a, the curved segment 235b, and the contact segment 235c of each first contact finger 235 may have the same widths as each other in the longitudinal direction Y-Y. For example, each first contact finger 235 may have a consistent width in an extension direction thereof.

In some embodiments, as shown in FIGS. 5A to 6D, for each third conductive element 230, the straight segment 236a, the curved segment 236b, and the contact segment 236c of each second contact finger 236 may have the same widths as each other in the longitudinal direction Y-Y. For example, each second contact finger 236 may have a consistent width in an extension direction thereof.

In some embodiments, as shown in FIGS. 5A to 6D, for each third conductive element 230, the one first contact finger 235 and the two second contact fingers 236 may be aligned with each other in the longitudinal direction Y-Y, the one first contact finger 235 has a first cross-sectional profile perpendicular to the longitudinal direction Y-Y, and each second contact finger 236 has a second cross-sectional profile perpendicular to the longitudinal direction Y-Y. The first cross-sectional profile may be identical to the second cross-sectional profile.

In some embodiments, as shown in FIGS. 5A to 6D, each third conductive element 230 may be formed from a single piece of conductive material. For example, each third conductive element 230 includes a single layer. It should be appreciated that the present application may not be limited thereto.

Although the mating end 231 of the third conductive element 230 is described above as having one first contact finger 235 and two second contact fingers 236, it should be appreciated that the present application may not be limited thereto. In some other embodiments, the mating end 231 of each third conductive element 230 may include at least one first contact finger 235 and at least two second contact fingers 236. Each of the at least one first contact finger 235 and the at least two second contact fingers 236 has a mating contact portion. The mating contact portion 235d of each first contact finger 235 has a width W1 in the longitudinal direction Y-Y, and the mating contact portion 236d of each second contact finger 236 has a width W2 in the longitudinal direction Y-Y. When the third conductive element 230 is disposed in the housing 100, the at least one first contact finger 235 is closer to the divider 105b of the housing 100 in the longitudinal direction Y-Y than the at least two second contact fingers 236. The at least one first contact finger 235 and the at least two second contact fingers 236 are aligned with and spaced apart from each other in the longitudinal direction Y-Y. The mating contact portion 235d of the first contact finger 235 of the at least one first contact finger 235 and the mating contact portion 236d of the second contact finger 236, adjacent to the first contact finger 235, of the at least two second contact fingers 236 are spaced center-to-center from each other by the pitch P1 in the longitudinal direction Y-Y, and the mating contact portions 236d of two adjacent ones of the at least two second contact fingers 236 are spaced center-to-center from each other by the second pitch P2 in the longitudinal direction Y-Y. In addition, When the at least one first contact finger 235 includes at least two first contact fingers 235, the mating contact portions 235d of the two adjacent first contact fingers 235 may be spaced center-to-center from each other by a pitch (not shown), which may be greater than or equal to the pitch P1, in the longitudinal direction Y-Y.

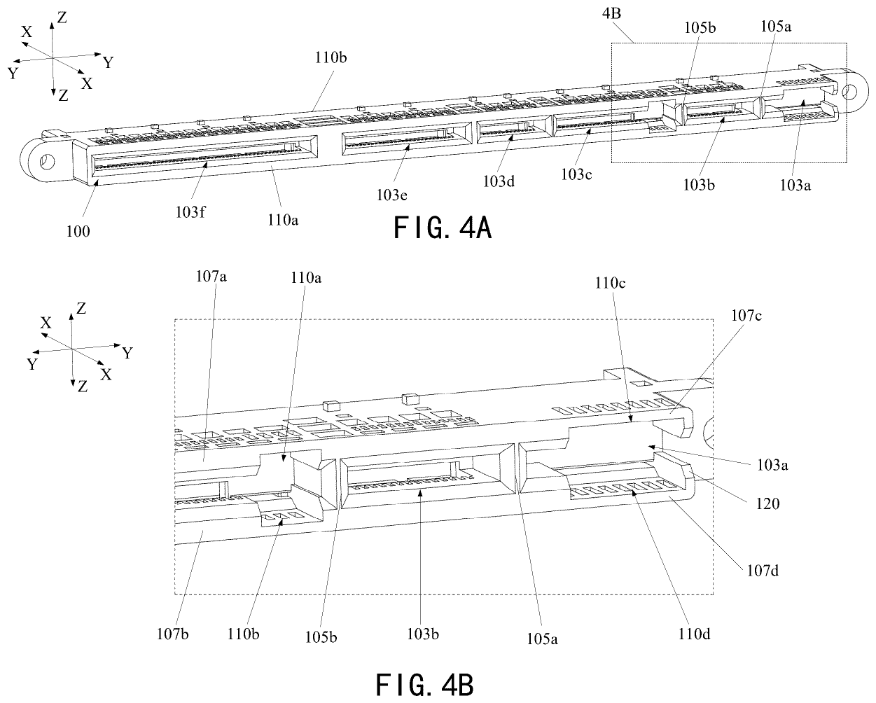

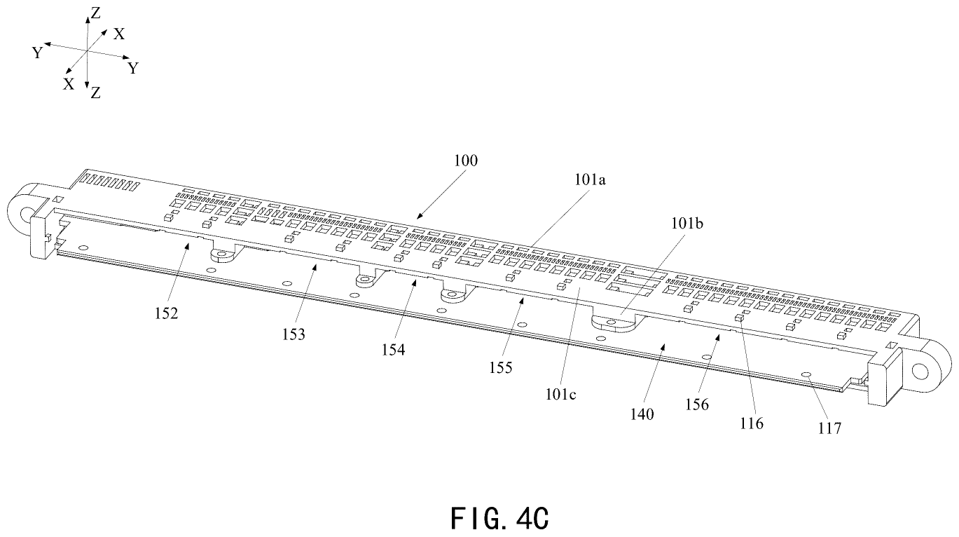

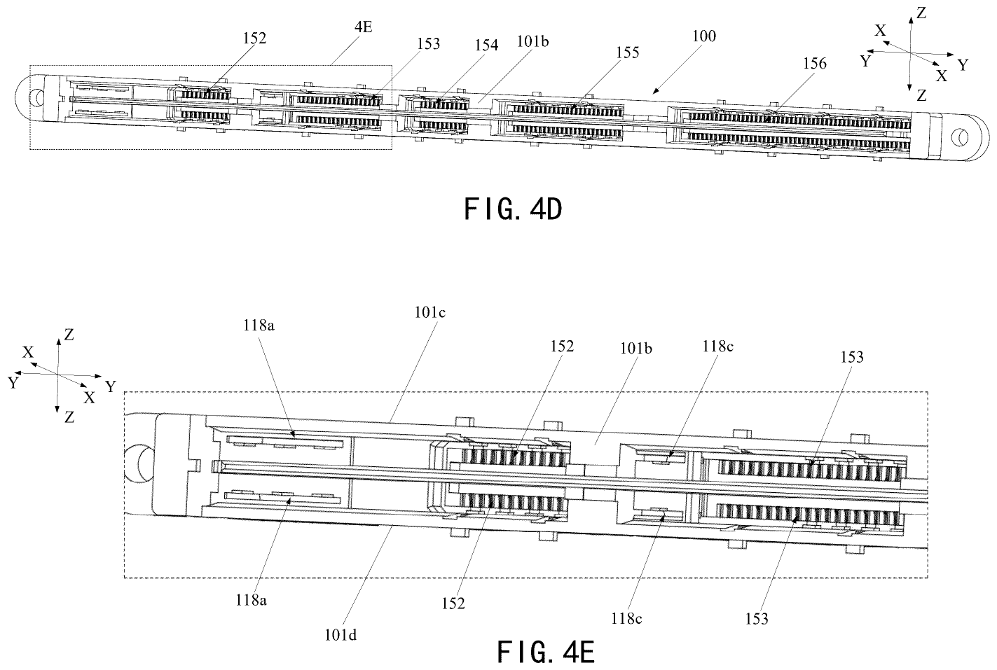

In some embodiments, as shown in FIGS. 3C and 3D, the third conductive elements 230 may be inserted in the housing 100. As shown in FIG. 4E, the housing 100 may include third receiving spaces 118c extending into the housing 100 from the second face 101b and in communication with corresponding channels. The intermediate portion 233 of the third conductive element 230 may engage with walls of the third receiving space 118c to hold the third conductive element 230 in the third receiving space 118c. In some other embodiments, the third conductive element 230 may be held in the corresponding channel by any suitable terminal retention structure (not shown).

The fourth conductive elements 240 disposed in the third slot 103c may be arranged in two terminal rows. Each of the two terminal rows may extend in the longitudinal direction Y-Y.

In some embodiments, as shown in FIGS. 7A and 7B, the electrical connector 10 may include an assembly housing 400 (which may also be referred to as “a terminal assembly housing”) for retaining the fourth conductive elements 240 in the housing 100. The assembly housing 400 may be formed from an insulative material. Examples of insulative materials suitable for forming the assembly housing 400 include, but are not limited to, plastic, nylon, liquid crystal polymer (LCP), polyphenylene sulfide (PPS), high temperature nylon or polyphenylene oxide (PPO) or polypropylene (PP).

Two assembly housings 400 are shown in FIGS. 7A and 7B. The fourth conductive elements 240 are held by the two assembly housings 400 in two terminal rows that are opposed to and spaced apart from each other in the vertical direction Z-Z. As shown in FIG. 2F, the mating contact portions of the conductive elements of the two terminal rows may be opposed to and spaced apart from each other on both sides of the third slot 103c. The corresponding insert portion 36c of the circuit board 30 may be inserted between the mating contact portions of the conductive elements of the two terminal rows. The terminal row located on one side of the third slot 103c may be referred to as “an upper terminal row”, and the terminal row located on the opposed side of the third slot 103c may be referred to as “a lower terminal row”. It should be appreciated that this only indicates a relative positional relationship, rather than an absolute positional relationship, between the two terminals rows when disposed in the housing 100.

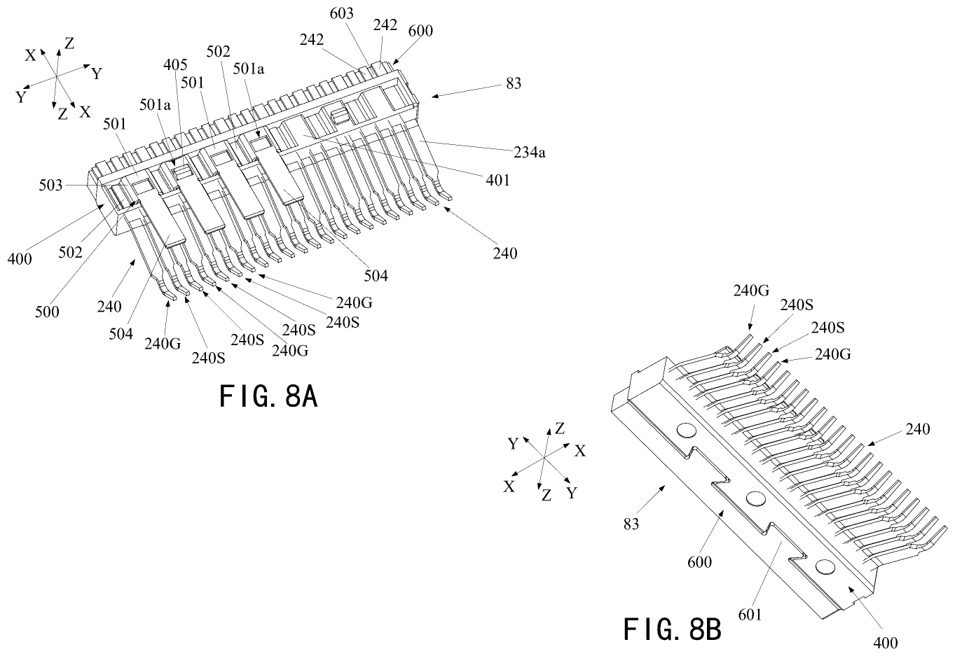

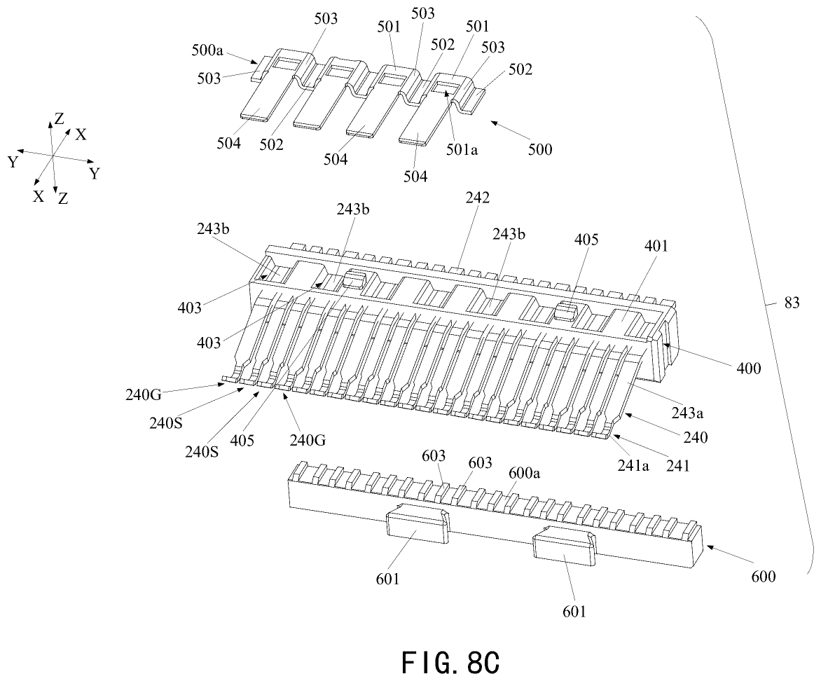

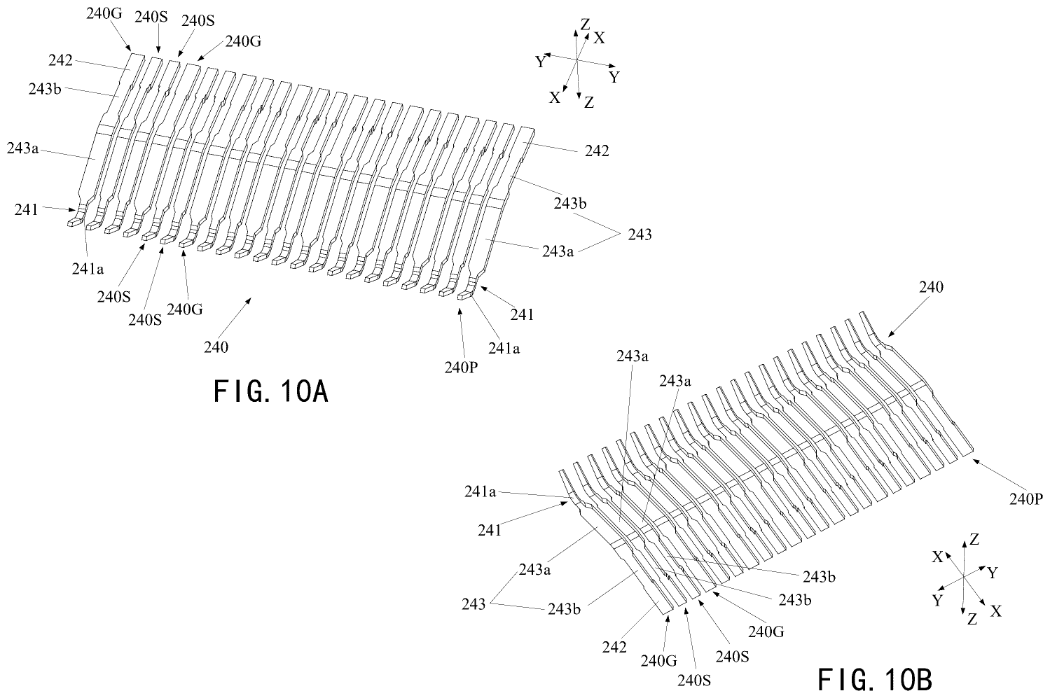

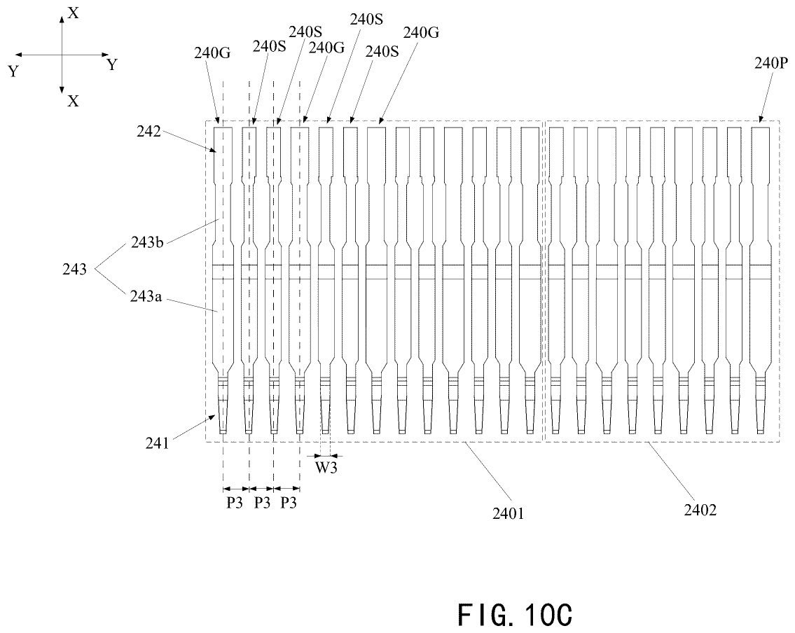

FIGS. 8A to 8C illustrate the upper terminal row held by the assembly housing 400, and FIGS. 10A to 10C illustrate the fourth conductive elements 240 of the upper terminal row. The intermediate portion 243 of each fourth conductive element 240 extends between the mating end 241 and the contact tail 242 thereof, and the intermediate portion 243 includes a first segment 243a and a second segment 243b. The first segment 243a is closer to the mating end 241 than the second segment 243b. As shown in FIGS. 8A to 8C, the assembly housing 400 may be disposed around the second segments 243b of the intermediate portions 243 of the fourth conductive elements 240 to retain the fourth conductive elements 240, so that the fourth conductive elements 240 are disposed in a row in the longitudinal direction Y-Y and so that the first segments 243a of the intermediate portions 243 and the mating ends 241 of the fourth conductive elements 240 are disposed outside of the assembly housing 400 and oriented in the lateral direction X-X.

In some embodiments, the assembly housing 400 may be molded around the second segments 243b of the intermediate portions 243 of the fourth conductive elements 240. For example, the assembly housing 400 may be a member overmolded on the second segments 243b of the intermediate portions 243 of the fourth conductive elements 240. In some other embodiments, the assembly housing 400 may be formed with receiving slots for inserting the second segments 243b of the intermediate portions 243 of the fourth conductive elements 240.

At least a portion of the fourth conductive elements 240 may be configured for transmitting signals. Such signals may be high-speed signals, such as differential signals. For example, a first portion 2401 of the fourth conductive elements 240 (which are schematically circled by the dashed box in FIG. 10C) may be configured for transmitting differential signals. The first portion 2401 of the fourth conductive elements 240 may include ground terminals 240G and pairs of signal terminals 240S forming differential signal pairs for carrying differential signals. One signal terminal of a pair of signal terminals 240S may be energized by a first voltage, and the other signal terminal may be energized by a second voltage. The voltage difference between the pair of signal terminals 240S represents a signal. The ground terminals 240G and the signal terminals 240S may have similar features. In some embodiments, as shown in FIGS. 10A to 10C, a width of the ground terminal 240G in the longitudinal direction Y-Y may be greater than a width of the signal terminal 240S in the longitudinal direction Y-Y. It should be appreciated that the present application may not be limited thereto. In some other embodiments, the ground terminals 240G and the signal terminals 240S may have identical configurations.

As shown in FIG. 10C, the ground terminals 240G may be arranged adjacent to each pair of signal terminals 240S to separate the pairs of signal terminals 240S from each other, thereby reducing crosstalk between signals to improve signal integrity. The ground terminals 240G and the pairs of signal terminals 240S are arranged in a “G-S-S-S-G-S-S . . . G-S-S-G” manner (wherein “G” represents the ground terminals 240G and “S” represents the signal terminals 240S), wherein a ground terminal 240G is disposed between two adjacent pairs of signal terminals 240S. Separating multiple pairs of signal terminals 240S from each other with the ground terminals 240G can reduce crosstalk, thereby improving signal integrity.

A second portion 2402 of the fourth conductive elements 240 (which are schematically circled by the dashed box in FIG. 10C) may be configured for transmitting power and/or signals. For example, the second portion 2402 of the fourth conductive elements 240 may be configured for transmitting signals, such as sideband signals. As another example, the second portion 2402 of the fourth conductive elements 240 may include power terminals 240P configured for transmitting power. The fourth conductive elements 240 of the first portion 2401 and the second portion 2402 may have similar features.

As shown in FIGS. 10A and 10B, the mating contact portions 241a of the fourth conductive elements 240 may be aligned with and spaced apart from each other in the longitudinal direction Y-Y, and the contact surfaces of the mating contact portions 241a may be coplanar with each other. As shown in FIG. 10C, the mating contact portions 241a of the ground terminals 240G and the signal terminal 240S may have substantially the same widths W3 in the longitudinal direction Y-Y. The mating contact portions 241a of two adjacent terminals of the signal terminals 240S and the ground terminals 240G may be spaced center-to-center from each other by a third pitch P3 in the longitudinal direction Y-Y.

It can be contemplated that the mating contact portion 241a of each fourth conductive element 240 of the upper terminal row may have a width W3 in the longitudinal direction Y-Y, and the two mating contact portions 241a of two adjacent terminals of the upper terminal row may be spaced center-to-center from each other by the third pitch P3 in the longitudinal direction Y-Y. In a specification such as SFF-TA-1037, the pitch P3 may be 0.6 mm. In some other embodiments, the pitch P3 may be less than or greater than 0.6 mm.

As shown in FIG. 2F, the third slot 103c may include a first section 1031 adjacent to the divider 105b, and a second section 1032 extending from the first section 1031 away from the divider 105b in the longitudinal direction Y-Y. The mating contact portions 231a of the mating ends 231 of the third conductive elements 230 may extend into the first section 1031, and the mating contact portions 241a of the mating ends 241 of the fourth conductive elements 240 may extend into the second section 1032.

As shown in FIGS. 2F and 5A to 5B, the mating contact portions 301a of the two third conductive elements 230 may be arranged in two first rows in the longitudinal direction Y-Y and exposed in the first section 1031 of the third slot 103c. The mating contact portions 241a of the fourth conductive elements 240 may be arranged in two second rows in the longitudinal direction Y-Y and exposed in the second section 1032 of the third slot 103c. Each of the two first rows is aligned with and spaced apart from a corresponding one of the two second rows in the longitudinal direction Y-Y.

A pitch (e.g., “P1” or “P2” in FIG. 6C) by which two adjacent mating contact portions (e.g., two adjacent ones of the mating contact portion 235d of the first contact finger 235 and the mating contact portions 236d of the second contact fingers 236) of each first row are spaced center-to-center from each other in the longitudinal direction Y-Y is greater than a pitch (e.g., “P3” in FIG. 10C) by which two adjacent mating contact portions of each second row are spaced center-to-center from each other in the longitudinal direction Y-Y. For example, the pitch P1 is greater than the pitch P3, and the pitch P2 is greater than the pitch P3. Further, the pitch P1 is greater than the pitch P2. As described above, the mating contact portion 235d of the first contact finger 235 of the third conductive element 230 has a width W1 in the longitudinal direction Y-Y, and the mating contact portion 236d of the second contact finger 236 has a width W2 in the longitudinal direction Y-Y. The mating contact portion 243d of each of the fourth conductive elements 240 may have a width W3 in the longitudinal direction Y-Y (FIG. 10C). The width W1 is greater than the width W3, and the width W2 is greater than the width W3.

One or more of the above features of the third conductive elements 230 enables the third conductive elements 230 to generate less heat for a given current, as compared to power terminals such as the power terminals 240P. For example, one or more of the above features of the third conductive elements 230 enable the third conductive elements 230 to transmit significantly more power at a maximum temperature rise that can be tolerated. For example, the two third conductive elements 230 are capable of transmitting a power of up to 200 W or even more with a maximum temperature rise of 30° C. above ambient temperature.

The inventors have recognized and appreciated that by disposing the two third conductive elements 230 and the fourth conductive elements 240 in the third slot 103c, and configuring the third conductive elements 230 for transmitting power and configuring at least a portion of the fourth conductive elements 240 for transmitting signals, it is possible to enable the electrical connector 10 to provide both high-quality, high-speed signal transmission and high-power transmission without significantly increasing the space occupied by the electrical connector 10 in the electronic system 1. Such a configuration enables the electrical connector 10 to be backward compatible with add-in cards designed and manufactured in accordance with a particular specification, such as add-in cards (for example, pluggable multi-purpose modules (PMMs)) designed and manufactured in accordance with the current version of SFF-TA-1037. Such add-in cards, for example, were originally designed to require mate with multiple electrical connectors. With the configuration described above, the electrical connector 10 can integrate the functions of the electrical connectors so as to mate with such add-in cards. In this way, the number of components of the electronic system 1 can be reduced, thereby increasing the integration and the manufacturing and assembly efficiency of the electronic system 1.

In some embodiments, as shown in FIGS. 2I, 8A, and 10C, the second portion 2402 of the fourth conductive elements 240 may be disposed between the first portion 2401 of the fourth conductive elements 240 and the two third conductive elements 230 in the longitudinal direction Y-Y. With such a configuration, interference to differential signals transmitted by the first portion 2401 of the fourth conductive elements 240 can be reduced. In some embodiments, the second portion 2402 of the fourth conductive elements 240 is disposed in a region of each of the two second rows immediately adjacent the corresponding first row. In addition, the power terminal(s) 240P of the second portion 2402 of the fourth conductive elements 240 may be disposed between the signal terminals of the second portion 2402 and the two third conductive elements 230 in the longitudinal direction Y-Y.

In some embodiments, each of the two first rows and a corresponding one of the two second rows are separated from each other by a pitch, which is at least twice the pitch P3, in the longitudinal direction Y-Y. With such a configuration, interference to the differential signals transmitted by the first portion 2401 of the fourth conductive elements 240 can be effectively reduced.

In some embodiments, the pitch P1 or the pitch P2 may be greater than or equal to 0.8 mm. For example, the pitch P1 or the pitch P2 may be 0.8 mm, 0.9 mm, 1.0 mm, etc.

In some embodiments, the pitch P1 or the pitch P2 may be greater than 1.5 times the pitch P3. For example, the pitch P1 or the pitch P2 may be N times the pitch P3, wherein N is an integer greater than 1.

Although the upper terminal row is described above as including ground terminals 240G and pairs of signal terminals 240S, it should be appreciated that the present application may not be limited thereto. For example, a single signal terminal 240S or more than two signal terminals 240S may be arranged between two adjacent ground terminals 240G. For example, the upper terminal row may include signal terminals 240S and ground terminals 240G. The signal terminals 240S may be arranged in groups of signal terminals 240S spaced apart from each other in the longitudinal direction Y-Y, and two adjacent ones of the groups of signal terminals 240S are provided with a ground terminal 240G therebetween. Each group of signal terminals 240S may include at least one signal terminal 240S.

Although each row of fourth conductive elements 240 is described above as being held by a single assembly housing 400, it should be appreciated that the present application may not be limited thereto. In some other embodiments, more or fewer assembly housings may be utilized. For example, the two assembly housings 400 shown in FIGS. 7A and 7B may be replaced with a single assembly housing. As another example, the fourth conductive elements 240 may be held in one and the same row by more than one assembly housing. It should also be appreciated that there may be no assembly housing, but rather the fourth conductive elements 240 may be disposed directly in the housing 100, such as by inserting the fourth conductive elements 240 into corresponding receiving spaces formed in the housing 100, or molding the housing 100 around the fourth conductive element 240.

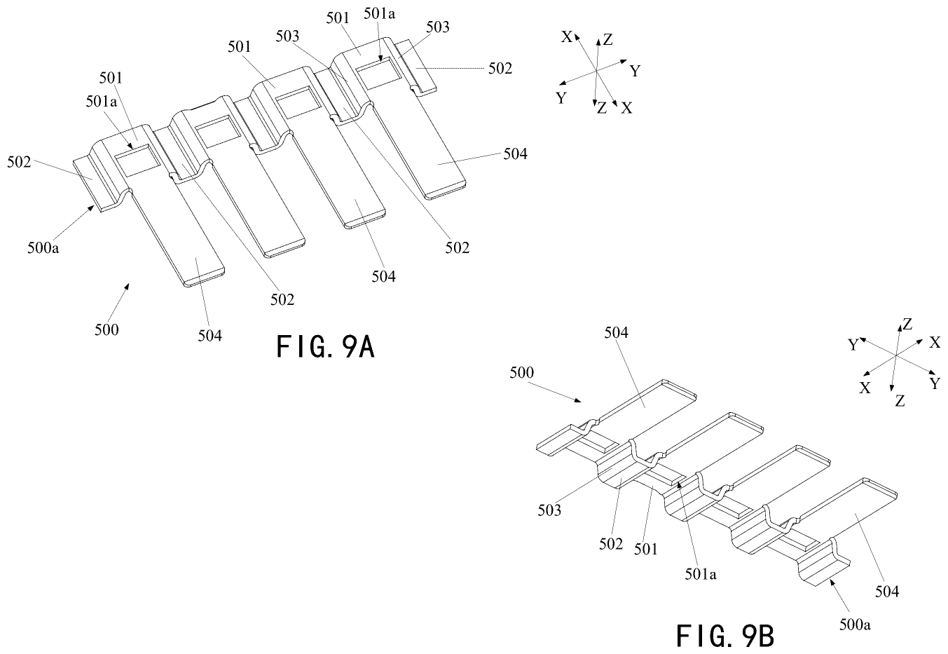

In some embodiments, as shown in FIGS. 8A to 8C, the electrical connector 10 may include a shielding member 500. The shielding member 500 may improve signal transmission performance of the electrical connector 10. FIGS. 9A and 9B illustrate the shielding member 500.

As shown in FIGS. 8A to 9B, the shielding member 500 may include a body 500a and extensions 504. The body 500a of the shielding member 500 is disposed on the assembly housing 400. Each of the extensions 504 extends from the body 500a beyond the assembly housing 400 in the lateral direction X-X, and extends above the first segments 243a of the intermediate portions 243 of a corresponding group (a pair of signal terminals 240S in the drawings) of the signal terminals 400S. With such a configuration, it is possible to provide shielding protection along the signal transmission path to improve signal integrity, thereby improving the signal transmission performance of the electrical connector 10.

In some embodiments, as shown in FIG. 8C, the assembly housing 400 may include a first surface 401 and recesses 403. Each of the recesses 403 is recessed into the assembly housing 400 from the first surface 401 in the vertical direction Z-Z to expose at least a portion of the second segment 243b of a corresponding one of the ground terminals 240G. As shown in FIGS. 8A, 8C, and 9A to 9B, the body 500a of the shielding member 500 may include plateaus 501, valleys 502, and connecting portions 503 joining the adjacent plateaus 501 and valleys 502. When the body 500a of the shielding member 500 is disposed on the assembly housing 400, the plateaus 501 are disposed on the first surface 401. Each valley 502 and corresponding connecting portions 503 are received in a corresponding one of the recesses 403, and the valley 502 is electrically coupled to at least a portion of the second segment 243b of a corresponding ground terminal exposed by the corresponding recess 403.

Disposing the body 500a of the shielding member 500 on the assembly housing 400 can provide shielding protection to the signal terminals 240S. Electrically coupling the body 500a to the ground terminals 240G via the valleys 502 enables the electromagnetic interference absorbed by the body 500a to be connected to the ground and can reduce the effect of electrical resonance. With such a configuration, signal integrity can be improved, thereby improving the signal transmission performance of the electrical connector 10.

In some embodiments, each valley 502 of the shielding member 500 is in direct contact with at least a portion of the second segment 243b of the corresponding ground terminal exposed by the corresponding recess 403, and the direct contact is a surface contact. This surface contact can reduce the impedance at the joint part between the valley 502 and the ground terminal 240G, and mitigate or even eliminate the charge accumulation problem.

In some embodiments, the shielding member 500 may be formed from a conductive material, such as a metallic material. In some other embodiments, the shielding member 500 may be formed from a lossy material. In this case, each valley 502 of the shielding member 500 may be in direct contact with or capacitively coupled with at least the portion of the second segment 243b of the corresponding ground terminal exposed by the corresponding recess 403. For example, the valleys 502 of the shielding member 500 may be attached to the ground terminal 240G by any suitable process, such as laser welding, so as to retain the body 500a of the shielding member 500 on the assembly housing 400. As another example, the body 500a of the shielding member 500 may be secured on the assembly housing 400 by any suitable means, such as a snap fit, so as to bring the valley 502 into direct contact or capacitive coupling with the ground terminal 240G.

Materials that dissipate a sufficient portion of the electromagnetic energy interacting with that material to appreciably impact the performance of a connector may be regarded as lossy. A meaningful impact results from attenuation over a frequency range of interest for a connector. In some embodiments, lossy material may suppress resonances within ground structures of the electrical connector and the frequency range of interest may include the natural frequency of the resonant structure, without the lossy material in place. In some embodiments, the frequency range of interest may be all or part of the operating frequency range of the electrical connector.

The receipt of the valleys 502 and the corresponding connecting portions 503 in the corresponding recess 403 can help reliably retain the shielding member 500 on the assembly housing 400. It should be appreciated that the present application may not be limited thereto. The shielding member 500 can be secured on the assembly housing 400 in any other suitable manner.

Each of the plateaus 501 of the body 500a of the shielding member 500 may be disposed above the second segment 243b of the intermediate portions 243 of a corresponding group of the groups of signal terminals 240S in the vertical direction Z-Z, and may be spaced apart from the second segments 243b of the intermediate portions 243 of the corresponding group of signal terminals 240S by the assembly housing 400. Each of the extensions 504 may extend from a corresponding one of the plateaus 501 in the lateral direction X-X and above the first segments 243a of the intermediate portions 243 of the corresponding group of signal terminals 240S corresponding to the corresponding plateau 501. With such a configuration, the plateau 501 and the corresponding extension 504 of the shielding member 500 may provide shielding protection above the first segments 243a and the second segments 243b of the intermediate portions 243 of the corresponding group of signal terminals 240S.

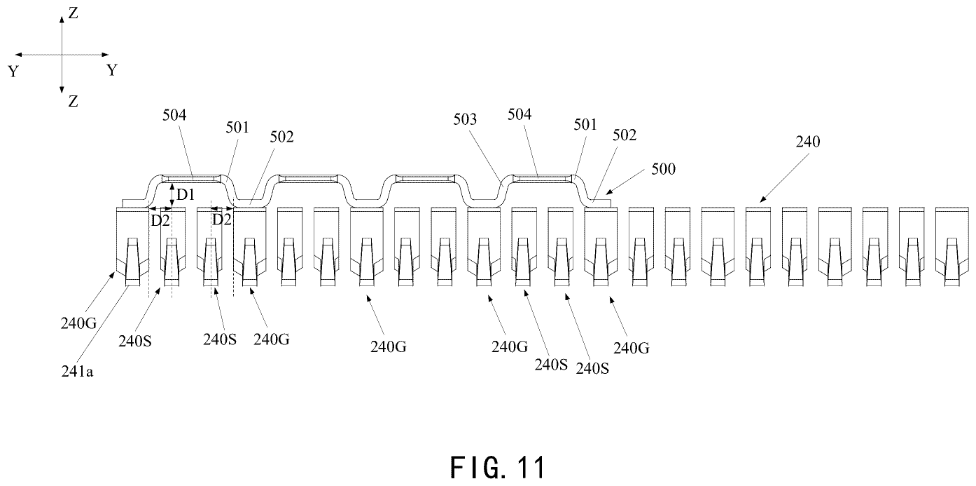

FIG. 11 illustrates the positional relationship between the shielding member 500 and the corresponding conductive elements 240 when the shielding member 500 is disposed on the assembly housing 400, wherein the assembly housing 400 is omitted. As shown in FIG. 11, for each group of the groups of signal terminals 240S, the second segments 243b of the intermediate portions 243 of the signal terminals 240S are spaced apart from the corresponding plateau 501 by a first distance D1 in the vertical direction Z-Z, and the center of the second segment 243b of the intermediate portion 243 of the signal terminal 240S is spaced apart from the edge of the second segment 243b of the intermediate portion 243 of the corresponding adjacent ground terminal by a second distance D2 in the longitudinal direction Y-Y. The first distance D1 may be approximate to the second distance D2. For example, the first distance D1 may be less than or equal to the second distance D2. With such a configuration, the plateau 501 of the shielding member 500 and the corresponding extension 504 may be used as a ground reference for the signal terminal 240S. In some embodiments, the first distance D1 may be equal to the second distance D2 so that the signal terminals 240S are shielded in a manner similar to the manner in which a wire with coaxial or biaxial cables is shielded.

In some embodiments, as shown in FIGS. 8A and 11, the extended range of the body 500a of the shielding member 500 in the longitudinal direction Y-Y may cover the second segments 243b of the intermediate portions 243 of the signal terminals 240S and the ground terminals.

In some embodiments, as shown in FIGS. 3E to 3F and 8A, the extended range of the body 500a of the shielding member 500 in the lateral direction X-X may cover at least the portion of the second segments 243b of the intermediate portions 243 of the signal terminals 240S and the ground terminals.

In some embodiments, as shown in FIGS. 8A to 8C and 10A to 10C, the first segment 243a of the intermediate portion 243 of the fourth conductive element 240 may join the second segment 243b and the mating end 241. As shown in FIGS. 3E to 3F and 8A, each of the extensions 504 may extend in the lateral direction X-X from a corresponding one of the plateaus 501 to a position above the joints between the mating ends 241 and the first segments 243a of the intermediate portion 243 of a corresponding group of signal terminals 240S corresponding to the corresponding plateau 501. With such a configuration, it is possible to provide shielding substantially along the first segments 243a and the second segments 243b of the intermediate portions 243 of the signal terminals 240S.

In some embodiments, as shown in FIGS. 8A, 8C, and 9A to 9B, each plateau 501 of the shielding member 500 may include an opening 501a extending through the plateau 501 in the vertical direction Z-Z. The opening 501a may be aligned with the second segments 243b of the intermediate portions 243 of a corresponding group of signal terminals 240S in the vertical direction Z-Z. This configuration can enhance the performance of the shielding member 500, thereby improving the signal transmission performance of the electrical connector 10.

In some embodiments, the assembly housing 400 may include protrusions 405 protruding from the first surface 401 in the vertical direction Z-Z. Each of the protrusions 405 extends through the openings 501a of a corresponding one of the plateaus 501 to retain the shielding member 500 on the assembly housing 400. In some examples, the protrusion 405 may engage with a mating feature (e.g., a notch) of the housing 100 when the assembly housing 400 is inserted into the housing 100, so as to retain the assembly housing 400 in the housing 100.

In some embodiments, as shown in FIGS. 8A and 8B, the first segments 243a of the intermediate portions 243 of the fourth conductive elements 240 may be aligned with and spaced apart from each other in the longitudinal direction Y-Y. The extensions 504 may be spaced apart from the first segments 243a of the intermediate portions 243 of the fourth conductive elements 240 in the vertical direction Z-Z. The extensions 504 do not contact the fourth conductive elements 240.

In some embodiments, as shown in FIGS. 10A and 10B, the second segments 243b of the intermediate portions 243 of the fourth conductive elements 240 extend in the lateral direction X-X, and are aligned with each other in the longitudinal direction Y-Y, the second segments 243b collectively define a plane perpendicular to the vertical direction Z-Z (e.g., a plane PL corresponding to the upper terminal row is shown schematically with dashed lines in FIGS. 3E and 3F). As shown in FIG. 3E, the extensions 504 may extend parallelly to the plane PL on a first side of the plane PL. The extensions 504 may be straight bars. As shown in FIGS. 3E and 3F, the first segments 243a of the intermediate portions 243 of the fourth conductive elements 240 may extend obliquely from the second segments 243b away from the plane PL to a second side of the plane PL opposite to the first side, so that the mating ends 241 extend into the third slot 103c. When the insert portion 36c of the circuit board 30 is inserted into the third slot 103c, the first segments 243a of the intermediate portions 243 of the fourth conductive elements 240 may be pushed by the insert portion 36c to be deflected towards the plane PL. When the first segments 143a of the fourth conductive elements 240 are deflected towards the plane PL, the extension 504 does not contact the first segments 143a. In some embodiments, the extension 504 may be received in the receiving slot 190 (FIG. 3E) of the housing 100 so as to be spaced apart from the space in the housing 100, in which the first segments 143a are disposed, by the housing 100. It should be appreciated that the present application may not be limited thereto.

In some embodiments, as shown in FIG. 8A, each of the extensions 504 may be disposed above the first segments 243a of the intermediate portions 243 of a corresponding group of the groups of signal terminals 240S in the vertical direction Z-Z, and does not extend to a position above the ground terminal adjacent to the corresponding group of signal terminals 240S.

As shown in FIGS. 8A to 8C, the contact tails 242 of the fourth conductive elements 240 extend out of the assembly housing 400. The contact tail 242 of the fourth conductive element 240 may extend from the second segment 243b of the intermediate portion 243 oppositely to the first segment 143a. In some embodiments, as shown in FIGS. 8A to 8C, the contact tail 242 of the fourth conductive element 240 may be configured to attach a cable 40 (e.g., by welding). For example, signal terminals 240S of the fourth conductive elements 240 may be used to attach a signal conductor or wire of the cable 40, a ground terminal 240G adjacent to the signal terminal 240S may be used to attach a shield conductor or wire for the signal conductor or wire, and the power terminal 240P may be used to attach a power cable 40 for transmitting power.

In some embodiments, as shown in FIGS. 8A to 8C, the electrical connector 10 may include a spacer 600 configured to support the contact tails 242 of the fourth conductive elements 240. The spacer 600 may be formed from an insulative material. Examples of insulative materials suitable for forming the spacer 600 include, but are not limited to, plastic, nylon, liquid crystal polymer (LCP), polyphenylene sulfide (PPS), high temperature nylon or polyphenylene oxide (PPO) or polypropylene (PP). The contact tails 242 of the fourth conductive elements 240 may be disposed on a surface 600a of the spacer 600. The spacer 600 may include ribs 603 protruding from the surface 600a in the vertical direction Z-Z. The contact tails 242 of adjacent ones of the fourth conductive elements 240 may be separated by a corresponding rib 603 in the lateral direction X-X. For example, as shown in FIG. 8B, the spacer 600 may be coupled to the assembly housing 400, such as by dovetail-shaped attachment portions 601. In some other embodiments, the spacer 600 may be integrally formed with the assembly housing 400.

As shown in FIGS. 8A to 8C, the fourth conductive elements 240, the assembly housing 400, the shielding member 500, and the spacer 600 may form a terminal assembly 83. The fourth conductive elements 240, the assembly housing 400, the shielding member 500, and the spacer 600 may be assembled together before mounted into the housing 100, so as to form the terminal assembly 83. Such a configuration may improve the efficiency of assembly of the electrical connector 10. It should be appreciated that the present application may not be limited thereto. The terminal assembly 83 may also include other components. In some embodiments, the terminal assembly 83 may include corresponding cables 40 to which the fourth conductive elements 240 are attached. In some other embodiments, the terminal assembly 83 may be devoid of the spacer 600 and/or the shielding member 500.

The terminal assembly 83 may be inserted into the housing 100, such as through a space 153 recessed into the housing 100 from the second face 101b of the housing 100. The assembly housing 400 may be retained in place by the housing 100, thereby retaining the fourth conductive elements 240 in the housing 100.

It should be appreciated that the specific features of the upper terminal row disposed in the third slot 103c and the corresponding assembly housing 400, shielding member 500, and spacer 600 are described above. The upper terminal row and the corresponding assembly housing 400, shielding member 500, and spacer 600 may form a terminal assembly 83. Turning back to FIGS. 7A to 7B, similar to the upper terminal row, the lower terminal row may form a terminal assembly 83 together with a corresponding assembly housing, shielding member, and spacer. The features of the two terminal assemblies 83 shown in FIGS. 7A to 7B may be similar to each other. For example, the two terminal assemblies 83 may be symmetrical about each other about an imaginary plane parallel to the lateral direction X-X and the longitudinal direction Y-Y. These similar features of the lower terminal row and the corresponding assembly housing, shielding member, and spacer may not be repeated.

It should also be appreciated that the two terminal assemblies 83 shown in FIGS. 7A to 7B may be combined into a single terminal assembly 83. For example, the two assembly housings of the two terminal assemblies 83 may be secured together or formed into one piece.

As shown in FIGS. 2A to 2F and 2I, two first conductive elements 210 are disposed in the housing 100 in correspondence with the first slot 103a. Although two first conductive elements 210 are shown in the drawings, it should be appreciated that only one first conductive element 210, or more than two first conductive elements 210, may be included. For example, one or more pairs of first conductive elements 210 may be included.

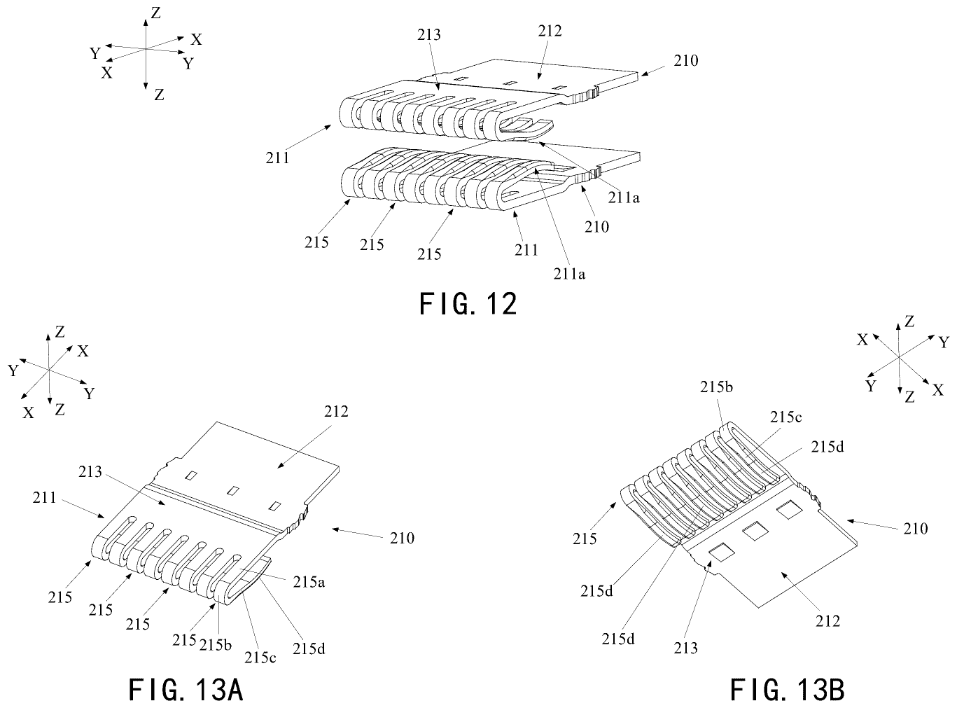

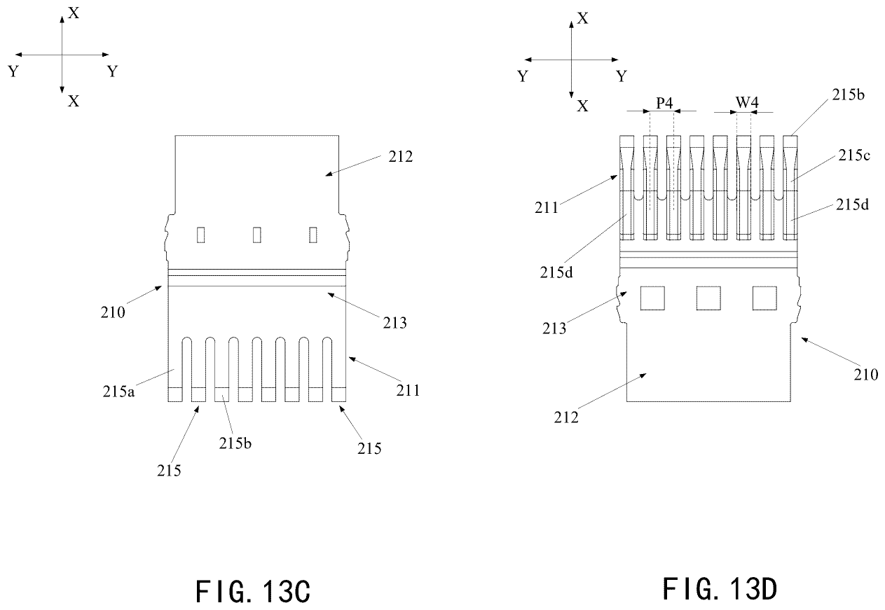

The first conductive elements 210 may be configured for transmitting power. Exemplary forms of the first conductive elements 210 are shown in FIGS. 12 to 13D. FIG. 12 is a perspective view illustrating the relative positional relationship of the two first conductive elements 210 when disposed in the housing 100. FIGS. 13A to 13D illustrate one of the first conductive elements 210.

As shown in FIGS. 12 to 13D, each first conductive element 210 includes a mating end 211 having a mating contact portion 211a, a contact tail 212 opposite to the mating end 211, and an intermediate portion 213 joining the mating end 211 and the contact tail 212. As will be described below, the mating end 211 of the first conductive element 210 may be configured to electrically contact the first conductive region 38a of the insert portion 36a of the circuit board 30. The contact tail 212 of the first conductive element 210 may be configured to be attached with a corresponding cable 40.

As shown, similar to the third conductive element 230, the first conductive element 210 may have greater dimensions in the lateral direction X-X, the longitudinal direction Y-Y, and the vertical direction Z-Z, as compared to the second conductive element 220 and the fourth conductive element 240. Further, the two first conductive elements 210 may be spaced apart from each other by a greater distance in the vertical direction Z-Z, as compared to the second conductive element 220 and the fourth conductive element 240. In addition, as will be described below, as compared to the mating contact portions of the second conductive element 220 and the fourth conductive element 240, the mating contact portions 211a of the first conductive elements 210 may be spaced center-to-center from each other by a greater distance in the longitudinal direction Y-Y.

It should be appreciated that the present application may not be limited thereto. For example, the first conductive element 210 may have a larger dimension in only one and two of the lateral direction X-X, the longitudinal direction Y-Y, and the vertical direction Z-Z, as compared to the second conductive element 220 and the fourth conductive element 240. As another example, there may be first conductive elements 210, and two adjacent first conductive elements 210 in the longitudinal direction Y-Y may be spaced apart from each other by a greater distance.

As shown in FIGS. 2B, 2D, and 2F, the housing 100 includes a third wall segment 107c and a fourth wall segment 107d separated apart from each other by the first slot 103a in the vertical direction Z-Z. For example, the third wall segment 107c and the fourth wall segment 107d of the housing 100 define the boundary of the first slot 103a in the vertical direction Z-Z. Further, the first slot 103a may be located at an end portion of the housing 100 in the longitudinal direction Y-Y. In this case, the divider 105a of the housing 100 and an end wall 120 of the housing 100 at the end portion define the boundary of the first slot 103a in the longitudinal direction Y-Y.

As shown in FIGS. 2B, 2D, and 2F, the housing 100 may include a third channel 110c and a fourth channel 110d. The third channel 110c and the fourth channel 110d extend from the third slot 103c into the third wall segment 107c and the fourth wall segment 107d in the vertical direction Z-Z, respectively, to accommodate the two first conductive elements 210. One of the two first conductive elements 210 at least partially extends in the third channel 110c, and the other one at least partially extends in the fourth channel 110d. The mating contact portions 211a of the mating ends 211 of the two first conductive elements 210 extend into the first slot 103a.

With such a configuration, the first conductive elements 210 with a larger dimension and/or a larger pitch can be integrated into the electrical connector 10 without the need to add an additional electrical connector to the electronic system 1. Such a configuration does not significantly increase the space occupied by the electrical connector 10 in the electronic system 1. With such a configuration, conductive elements for different purposes can be integrated into one and the same electrical connector 10 to enable the electrical connector 10 to provide both signal transmission and power transmission. For example, the electrical connector 10 can provide high-speed signal transmission and high-power transmission in a high-density configuration. Furthermore, such a configuration enables the electrical connector 10 to be backward compatible with add-in cards designed and manufactured according to specific specifications, such as those (for example, pluggable multi-purpose modules (PMMs)) designed and manufactured according to the current version of SFF-TA-1037. Such add-in cards, for example, were originally designed to require mate with multiple electrical connectors. With the configuration described above, the electrical connector 10 can integrate the functions of the electrical connectors so as to mate with such add-in cards. In this way, the number of components of the electronic system 1 can be reduced, thereby increasing the integration and the manufacturing and assembly efficiency of the electronic system 1.

As shown in FIG. 2F, the third wall segment 107c includes a third inner surface 1075 facing towards the first slot 103a and a third outer surface 1076 facing away from the first slot 103a, and the fourth wall segment 107d includes a fourth inner surface 1077 facing towards the first slot 103a and a fourth outer surface 1078 facing away from the first slot 103a. The third channel 110c extends into the third wall segment 107c from the third inner surface 1075 in the vertical direction Z-Z, and the fourth channel 110d extends into the fourth wall segment 107d from the fourth inner surface 1077 in the vertical direction Z-Z. In some embodiments, as shown in FIG. 2F, the third outer surface 1076 and the fourth outer surface 1078 may be planar surfaces.

In some other embodiments, a portion of the third wall segment 107c may protrude outwardly away from the first slot 103a to form a third accommodation portion or protrusion (not shown), and the third channel 110c may extend into the third accommodation portion from the third inner surface 1075 in the vertical direction Z-Z. Alternatively or additionally, a portion of the fourth wall segment 107d may protrude outwardly away from the first slot 103a to form a fourth accommodation portion or protrusion (not shown), and the fourth channel 110d may extend into the fourth accommodation portion from the fourth inner surface 1077 in the vertical direction Z-Z.

In some embodiments, as shown in FIG. 2F, the third channel 110c and the fourth channel 110d may be aligned with each other in the vertical direction Z-Z. It should be appreciated that the present application may not be limited thereto, and in some other embodiments, the third channel 110c and the fourth channel 110d may be offset from each other in the vertical direction Z-Z.

In some embodiments, as shown in FIG. 2F, the first slot 103a may extend from the divider 105a through the end wall 120 of the housing 100 at the end portion in the longitudinal direction Y-Y. Such a configuration can facilitate the insertion of the circuit board 30 into the electrical connector 10. Further, such a configuration enables the electrical connector 10 to be backward compatible with add-in cards designed and manufactured in accordance with specific specifications, such as those (for example, pluggable multi-purpose modules (PMMs)) designed and manufactured according to the current version of SFF-TA-1037. In addition, such a configuration can promote heat dissipation.

In some embodiments, as shown in FIG. 2F, the third channel 110c and the fourth channel 110d may be disposed in the longitudinal direction Y-Y closer to the end wall 120 than the divider 105. Such a configuration can reduce interference with signals transmitted over the second conductive elements 220. In addition, such a configuration can promote heat dissipation.

The first conductive element 210 disposed in the third channel 110c may be referred to as “an upper first conductive element”, and the first conductive element 210 disposed in the fourth channel 110d may be referred to as “a lower first conductive element”. It should be appreciated that this only indicates a relative positional relationship, rather than an absolute positional relationship, between the two first conductive elements. FIGS. 13A to 13D illustrate the upper first conductive element 210.

As shown in FIGS. 13A to 13D, the mating end 211 of the first conductive element 210 may include contact fingers 215 (eight in the drawings), but the present application may not be limited thereto, for example, the mating end 211 may have more or fewer than eight contact fingers 215. Each of the contact fingers 215 has a mating contact portion 215d extending into the first slot 103a. The mating contact portions 215d of the contact fingers 215 of the mating end 211 of the conductive element 210 may be configured to electrically contact the first conductive region 38a (e.g., one and the same continuous conductive region) of the insert portion 36a of the circuit board 30.

In some embodiments, as shown in FIG. 13D, the mating contact portions 215d of the contact fingers 215 of the mating end 211 of the first conductive element 210 may have equal widths W4 in the longitudinal direction Y-Y. The width W4 may be smaller than the width W1. The width W4 may be equal to or smaller than the width W2. The width W4 may be greater than or equal to the width W3.

In some embodiments, as shown in FIG. 13D, the mating contact portions 215d of every two adjacent ones of the contact fingers 215 of the mating end 211 of the first conductive element 210 may be spaced center-to-center from each other by equal pitches P4 in the longitudinal direction Y-Y.

In some embodiments, as shown in FIGS. 13A to 13D, the contact fingers 215 of the mating end 211 of the first conductive element 210 may have similar features. The contact fingers 215 of the mating end 211 of the first conductive element 210 may be aligned with and spaced apart from each other in the longitudinal direction Y-Y. The contact surfaces of the mating contact portions 215d of the contact fingers 215 may be coplanar with each other.

In some embodiments, as shown in FIGS. 3C and 3D, at least a portion of the intermediate portion 213 of each of the two first conductive elements 210 may be disposed in a corresponding one of the third channel 110c and the fourth channel 110d. For each first conductive element 210, each contact finger 215 may include a straight segment 215a, a curved segment 215b, and a contact segment 215c. The straight segment 215a extends from the intermediate portion 213 towards the first face 101a in the lateral direction X-X in the corresponding channel, the curved segment 215b is joined between the straight segment 215a and the contact segment 215c, the contact segment 215c extends from the curved segment 215b away from the first face 101a in the lateral direction X-X and into the first slot 103a, and the mating contact portion 216d is on the contact segment 215c.

In some embodiments, as shown in FIGS. 13A and 13B, for each first conductive element 210, straight segments 215a of the contact fingers 215 may be aligned with and spaced apart from each other in the longitudinal direction Y-Y.

In some embodiments, as shown in FIGS. 13A to 13D, for each first conductive element 210, the straight segment 215a, the curved segment 215b, and the contact segment 215c of each contact finger 215 may have the same widths as each other in the longitudinal direction Y-Y.

In some embodiments, as shown in FIGS. 13A and 13B, for each first conductive element 210, the contact fingers 215 may be aligned with each other in the longitudinal direction Y-Y, and cross-sectional profiles of the contact fingers 215 perpendicular to the longitudinal direction Y-Y may be the same.

In some embodiments, the first conductive elements 210 may be formed from a single piece of conductive material. For example, each first conductive element 210 includes a single layer. It should be appreciated that the present application may not be limited thereto.

In some embodiments, as shown in FIG. 3B, the first conductive element 210 may be inserted in the housing 100. As shown in FIG. 4E, the housing 100 may include a first receiving space 118a extending from the second face 101b into the housing 100 and in communication with a corresponding channel. The intermediate portion 213 of the first conductive element 210 may engage with wall segments of the first receiving space 118a to hold the first conductive element 210 in the first receiving space 118a. In some other embodiments, the first conductive element 210 may be held in the corresponding channel by any suitable terminal retention structure (not shown).

As shown in FIG. 12, the mating ends 211 of the two first conductive elements 210 (e.g., the upper first conductive element and the lower first conductive element) are symmetrical to each other about an imaginary plane parallel to the lateral direction X-X and the longitudinal direction Y-Y. For example, the mating end 211 of the lower first conductive element and the mating end 211 of the upper first conductive element may be symmetrical to each other. The lower first conductive element may be configured similar to the upper first conductive element.

At least a portion of the second conductive elements 220 disposed in the second slot 103b may be configured for transmitting signals. As shown in FIG. 2I, the features of the second conductive elements 220 may be similar to those of the fourth conductive elements 240 disposed in the third slot 103c. The second conductive elements 220 may form one or more terminal assemblies 82 together with corresponding assembly housing, shielding member, and spacer. The features of the terminal assembly 82 may be similar to those of the terminal assembly 83. These similar features may not be repeated.

Similar to the second conductive elements 220 disposed in the second slot 103b, at least a portion of the fifth conductive elements 250 disposed in the fourth slot 103d may be configured for transmitting signals, at least a portion of the sixth conductive elements 260 disposed in the fifth slot 103e may be configured for transmitting signals, and at least a portion of the seventh conductive elements 270 disposed in the sixth slot 103f may be configured for transmitting signals. Such signals may be high-speed signals, such as differential signals.

As shown in FIG. 2I, the fifth conductive elements 250, the sixth conductive elements 260, and the seventh conductive elements 270 may be configured similarly to the second conductive elements 220 or the fourth conductive elements 240, respectively. The fifth conductive elements 250 may form one or more terminal assemblies 84 together with corresponding assembly housing, shielding member, and spacer. The sixth conductive elements 260 may form one or more terminal assemblies 85 together with corresponding assembly housing, shielding member, and spacer. The seventh conductive elements 270 may form one or more terminal assemblies 86 together with corresponding assembly housing, shielding member, and spacer. The features of the terminal assemblies 84, 85, and 86 may be similar to those of the terminal assemblies 82 and 83. These similar features may not be repeated.

As shown in FIG. 2I, the first conductive elements 210, the second conductive elements 220, the third conductive elements 230, the fourth conductive elements 240, the fifth conductive elements 250, the sixth conductive elements 260, and the seventh conductive elements 270 may be attached with corresponding cables 40. For the second conductive elements 220, the fourth conductive elements 240, the fifth conductive elements 250, the sixth conductive elements 260, and the seventh conductive elements 270, the cables 40 may be attached to the contact tails of the conductive elements before the conductive elements are disposed in the housing 100, and then mounted to the housing 100 together with the conductive elements. For the first conductive elements 210 and the third conductive elements 230, the cables 40 may be attached to the contact tails of the conductive elements after the conductive elements are disposed in the housing 100. It should be appreciated that the present application may not be limited thereto.

In some embodiments, as shown in FIG. 4C, the housing 100 may include a platform 140. The platform 140 may extend out of the interior of the housing 100 beyond the second face 101b in the lateral direction X-X. The platform 140 may help to guide the insertion of the terminal assemblies 82, 83, 84, 85, and 86 into the corresponding receiving spaces 152, 153, 153, 154, 155, and 156 of the housing 100.

In some embodiments, as in FIGS. 1A and 1B, the rear member 700 may be configured to hold the cables 40 to be fixed relative to the housing 100. The rear member 700 may be overmolded onto the housing 100, for example onto the outer surface 101c, the outer surface 101d, and the platform 140. As shown in FIGS. 2G and 2H, protrusions 116 may be provided on the outer surface 101c and the outer surface 101d, and the platform 140 may include holes 117 to help hold the rear member 700 to be fixed relative to the housing 100. The cables 40 may be arranged adjacent to the platform 140, a portion of the cables 40 may extend on one side of the platform 140, and another portion of the cables 40 may be on the opposite side of the platform 140. The rear member 700 may be disposed around segments of the cables 40 and the platform 140. The rear member 700 may improve the mechanical reliability of the electrical connector 10.

Although the mating end 211 of each first conductive element 210 is shown as being in electrical contact with a first conductive region 38a of the insert portion 36a of the circuit board 30, and the mating end 231 of each third conductive element 230 is shown as being in electrical contact with a second conductive region 38b of the insert portion 36c of the circuit board 30, it should be appreciated that the present application may not be limited thereto. Each of the first conductive region 38a and the second conductive region 38b of the circuit board 30 may be replaced with conductive pads spaced from each other in the longitudinal direction Y-Y. In this case, the mating ends 211 of the first conductive elements 210 and the mating ends 231 of the third conductive elements 230 may be in electrical contact with the conductive pads, respectively. For example, the electrical connector 10 may be compatible with a circuit board having a continuous conductive area or a group of conductive pads at the insert portions 36a and 36c.

Having thus described several aspects of some embodiments of the invention, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, the electrical connector 10 may be configured as any suitable type of connector. The electrical connector 10 may be configured as a straddle mount electrical connector, a right-angle electrical connector, or a vertical electrical connector. The features of the contact tails of the conductive elements may be varied accordingly. For example, the electrical connector 10 may be configured to be mounted to a circuit board. The contact tails of the conductive elements may be configured to be attached to conductive pads on the circuit board or to be inserted into conductive through-holes in the circuit board.

As another example, the electrical component 3 may be any suitable type of electrical component, such as a plug connector.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprising a mating face, a first slot, a second slot, and a third slot each recessed into the housing from the mating face in a lateral direction, the first slot, the second slot, and the third slot sequentially arranged and spaced apart from each other in a longitudinal direction perpendicular to the lateral direction; and
a plurality of conductive elements, each conductive element comprising a mating end having a mating contact portion disposed in a respective slot of the first, second and third slots, a contact tail configured for cable termination, and an intermediate portion joining the mating end and the contact tail, the plurality of conductive elements comprising:
a plurality of first conductive elements, the mating contact portions of the mating ends of the plurality of first conductive elements disposed in the first slot;
a plurality of second conductive elements, the mating contact portions of the mating ends of the plurality of second conductive elements disposed in the second slot; and
a plurality of third conductive elements, the mating contact portions of the mating ends of the plurality of third conductive elements disposed in the third slot, wherein:
each first conductive element is wider than each third conductive element in the longitudinal direction; and
each third conductive element is wider than each second conductive element in the longitudinal direction.

2. The electrical connector of claim 1, wherein:
the plurality of first conductive elements are configured for transmitting power;
at least a portion of the plurality of second conductive elements are configured for transmitting signals; and
the plurality of third conductive elements are configured for transmitting power.

3. The electrical connector of claim 1, wherein:
the housing comprises a first wall segment, a second wall segment, a first divider joining the first and second wall segments and separating the second and third slots, and first and second channels adjacent to the first divider and extending from the third slot into the first wall segment and the second wall segment, respectively, in a vertical direction perpendicular to both the lateral direction and the longitudinal direction; and
the plurality of third conductive elements at least partially extend in the first and second channels.

4. The electrical connector of claim 3, wherein:
the plurality of conductive elements of the electrical connector comprises a plurality of fourth conductive elements;
the mating contact portions of the mating ends of the plurality of fourth conductive elements are disposed in the third slot;
each third conductive element is wider than each fourth conductive element; and
the plurality of third conductive elements are disposed closer to the first divider in the longitudinal direction than the plurality of fourth conductive elements.

5. The electrical connector of claim 4, wherein:
the housing comprises a plurality of third channels;
each third channel is narrower than each first or second channel; and
the plurality of fourth conductive elements at least partially extend in the plurality of third channels.

6. The electrical connector of claim 5, wherein:
at least a portion of the plurality of fourth conductive elements are configured for transmitting signals; and
each fourth conductive element has a same width as each second conductive element.

7. The electrical connector of claim 4, wherein:
the mating contact portions of the plurality of third conductive elements are arranged in two first rows in the longitudinal direction;
the two first rows are opposed to and spaced apart from each other in the vertical direction;
the mating contact portions of the plurality of fourth conductive elements are arranged in two second rows in the longitudinal direction;
the two second rows are opposed to and spaced apart from each other in the vertical direction; and
each of the two first rows and a corresponding one of the two second rows are aligned with and spaced apart from each other in the longitudinal direction.

8. The electrical connector of claim 7, wherein:
a pitch by which two adjacent mating contact portions of each first row are spaced from each other in the longitudinal direction is greater than a pitch by which two adjacent mating contact portions of each second row are spaced from each other in the longitudinal direction.

9. The electrical connector of claim 4, wherein:
each mating contact portion of the plurality of third conductive elements is wider than each mating contact portion of the plurality of fourth conductive elements in the longitudinal direction.

10. The electrical connector of claim 3, wherein:
the housing further comprises a third wall segment connected to the first wall segment, a fourth wall segment connected to the second wall segment, a second divider joining the third and fourth wall segments and separating the first and second slots, and fourth and fifth channels extending from the first slot into the third wall segment and the fourth wall segment in the vertical direction, respectively; and
the plurality of first conductive elements at least partially extend in the fourth and fifth channels.

11. The electrical connector of claim 10, wherein:
the housing comprises an end wall joining the third and fourth wall segments, and an extension adjacent the first slot and configured for connecting to a panel; and
the first slot is disposed between the second divider and the end wall and extends through the end wall.

12. An electrical connector comprising:
a housing comprising a mating face, a plurality of slots each recessed into the housing from the mating face in a lateral direction, and a plurality of dividers each disposed between adjacent slots of the plurality of slots, the plurality of slots aligned in a longitudinal direction perpendicular to the lateral direction; and
a plurality of conductive elements, each conductive element comprising a mating end having a mating contact portion disposed in a respective slot of the plurality of slots, a contact tail, and an intermediate portion joining the mating end and the contact tail, the plurality of conductive elements comprising:
a pair of first conductive elements, each first conductive element comprising a plurality of first mating contact portions disposed in a first slot of the plurality of slots,
a pair of second conductive elements, each second conductive element comprising a plurality of second mating contact portions disposed in a second slot of the plurality of slots, and
a plurality of third conductive elements comprising third mating contact portions disposed in respective slots of the plurality of slots other than the first slot, wherein:
each first mating contact portion is wider than each third mating contact portion in the longitudinal direction; and
each second mating contact portion is wider than each third mating contact portion in the longitudinal direction.

13. The electrical connector of claim 12, wherein:
each second mating contact portion is wider than each first mating contact portion in the longitudinal direction.

14. The electrical connector of claim 12, further comprising:
a plurality of cables comprising:
a plurality of first cables comprising first wires attached to the contact tails of the plurality of first conductive elements or the contact tails of the plurality of second conductive elements; and
a plurality of second cables comprising second wires attached to the contact tails of the plurality of third conductive elements.

15. The electrical connector of claim 14, wherein:
the housing comprises a second face opposite the mating face, and a platform extending beyond the second face and traversing the plurality of dividers; and
the plurality of cables are attached to respective contact tails on opposite sides of the platform.

16. The electrical connector of claim 14, wherein:
the housing comprises a pair of extensions disposed on opposite side of the housing in the longitudinal direction and configured for connecting to a panel.

17. The electrical connector of claim 12, wherein:
the mating contact portions of the plurality of second conductive elements have a first pitch of 0.6 mm;
the mating contact portions of each second conductive element has a second pitch greater than the first pitch; and
the mating contact portions of each second conductive element has a third pitch greater than the first pitch.

18. The electrical connector of claim 12, wherein:
the plurality of slots comprises a third slot disposed between the first and second slots, and fourth, fifth, and sixth slots separated from the first slot by the second slot.

19. The electrical connector of claim 18, wherein:
the sixth slot is the longest in the longitudinal direction among the plurality of slots and holds two rows of conductive elements;
the plurality of dividers comprises a divider that is the widest in the longitudinal direction; and
the sixth slot is separated from the fifth slot by the longest divider of the plurality of dividers.

20. The electrical connector of claim 18, wherein:
a plurality of shielding members at least partially extend in the plurality of slots other than the first slot; and
each shielding member comprises plateaus disposed above pairs of third conductive elements, valleys attached to third conductive elements disposed between adjacent pairs of the pairs of third conductive elements, and connecting portions joining adjacent plateau and valley.
